(19) United States
(12) Patent Application Publication
(10) Pub. No.: US 2022/0237116 A1
(43) Pub. Date: Jul. 28, 2022

(54) Method for Obtaining a Computational Result

(71) Applicant: The Darwin Engine Company Limited, Cambridge (GB)

(72) Inventors: Padraig HOOD, Reading (GB); Richard Hannam WEBB, London (GB)

(21) Appl. No.: 17/156,174

(22) Filed: Jan. 22, 2021

(51) Int. Cl. G06F 12/0802; G06F 17/16

(52) U.S. Cl. CPC G06F 12/0802; G06F 2212/60; G06F 17/16

(57) ABSTRACT

The present disclosure relates to a computer implemented method of obtaining a computation result, comprising: obtaining a first input; determining a distance measure between the first input and each of a plurality of stored entries, each of the plurality of stored entries comprising a stored input, a stored computation result and a stored uncertainty measure; determining if a stored entry meets a first criteria, wherein the first criteria is based on the distance measure and the stored uncertainty measure; if a stored entry meets the first criteria, determining a first computation result and a first computation uncertainty for the first input using a first set of one or more stored entries meeting the first criteria; and storing the first input, the first computation result and the first computation uncertainty as a first stored entry.

### FIELD

The present invention relates to a method for obtaining a computational result and a system for obtaining a computational result.

### BACKGROUND

Memoization is a technique used to improve computational efficiency. Memoization comprises storing results of computationally expensive functions in a cache, and returning the cached result when the same inputs are received in future. In this way, performing the full computation of the function can be avoided for a new input which is the same as a previous input. Instead, the cached result corresponding to the previous input is retrieved and returned. By employing such a technique, computer programs comprising one or more complex functions may be performed more quickly and using less computational resource. There is a continuing need to improve computational efficiency when implementing such programs.

### BRIEF DESCRIPTION OF FIGURES

The patent or application file contains at least one drawing executed in color. Copies of this patent or patent application publication with color drawing(s) will be provided by the Office upon request and payment of the necessary fee.

Systems and methods in accordance with non-limiting embodiments will now be described with reference to the accompanying figures in which:

FIG. 1 is a schematic illustration of a system in accordance with an embodiment;

FIG. 2(a) is a schematic illustration of a method according to an embodiment;

FIG. 2(b) is a schematic illustration of a method according to an alternative embodiment;

FIG. 3(a) illustrates an example function that may be used to determine a compound uncertainty in a method according to an embodiment;

FIG. 3(b) illustrates an alternative example function that may be used to determine a compound uncertainty in a method according to an embodiment;

FIG. 3(c) illustrates an alternative example function that may be used to determine a compound uncertainty in a method according to an embodiment;

FIG. 4(a) illustrates an example form of a compound uncertainty function that may be used in a method according to an embodiment;

FIG. 4(b) illustrates an alternative example form of a compound uncertainty function that may be used in a method according to an embodiment;

FIG. 5(a) is a schematic illustration of a network comprising stored entries from a cache;

FIG. 5(b) is a schematic illustration of a network comprising stored entries from a cache;

FIG. 6 is a schematic illustration of an example system according to an embodiment;

FIG. 7(a) is a schematic illustration of stored entries in a cache, represented as nodes;

FIG. 7(b) shows a schematic illustration of information stored in a node cache;

FIG. 7(c) is a schematic illustration of a connection cache;

FIG. 7(d) is a schematic illustration of stored entries in a cache, represented as nodes;

FIG. 7(e) is a schematic illustration of a process of re-processing a stored entry;

FIG. 7(f) is a flow chart of a method of re-processing a stored entry;

FIG. 8 is a schematic illustration of a method according to an embodiment;

FIG. 9 is a schematic illustration of a method according to an embodiment;

FIG. 10 shows an example of a training data set;

FIG. 11 is a schematic illustration of a method according to an embodiment;

FIG. 12(a) is a schematic illustration of a calculation of a result based on stored entries;

FIG. 12(b) is a schematic illustration of a calculation of a result based on stored entries;

FIG. 13 is a schematic illustration of a system in accordance with an embodiment which may be used in the first example;

FIG. 14 shows a schematic illustration of data stored in a node cache;

FIG. 15 illustrates a compression size of a target image file string used in the first example;

FIG. 16 is a schematic illustration of an example of the structure of a node cache;

FIG. 17 is a schematic illustration of an example of the structure of a connection cache;

FIG. 18 shows an example of stored data which is used in the method of the first example;

FIG. 19 is a schematic illustration of a network comprising stored entries from a cache used in the first example;

FIG. 20 is a schematic illustration of an alternative method in which an estimation engine uses recursion;

FIG. 21 is an illustration of an Ackley function;

FIG. 22 shows a set of results for various methods of determining an input corresponding to a maximum value for a function;

FIG. 23 shows results for a method of determining an input corresponding to a maximum value for a function according to comparative example 1;

FIG. 24 shows results for a methods of determining an input corresponding to a maximum value for a function according to example 1;

FIG. 25 shows results for a method of determining an input corresponding to a maximum value for a function according to example 2.

### DETAILED DESCRIPTION

According to an embodiment, there is provided a computer implemented method of obtaining a computation result, comprising:
obtaining a first input;
determining a distance measure between the first input and each of a plurality of stored entries, each of the plurality of stored entries comprising a stored input, a stored computation result and a stored uncertainty measure;
determining if a stored entry meets a first criteria, wherein the first criteria is based on the distance measure and the stored uncertainty measure;
if a stored entry meets the first criteria, determining a first computation result and a first computation uncertainty for the first input using a first set of one or more stored entries meeting the first criteria; and
storing the first input, the first computation result and the first computation uncertainty as a first stored entry.

In an embodiment, the method further comprises, if a stored entry meets the first criteria, determining if a stored entry meets a second criteria, wherein the second criteria is based on the distance measure; and if a stored entry meets the second criteria, providing a stored computation result corresponding to a stored entry meeting the second criteria as the computation result of the first input. The second criteria may further be based on the stored uncertainty measure.

In an embodiment, determining the computation result comprises computing a weighted combination of the first set of stored computation results. The weights may be determined based on the distance measures and the stored uncertainties. Computing the weighted combination may comprise one or more matrix calculations.

In an embodiment, the method further comprises:
identifying a stored entry to be updated;
determining an updated computation result and a computation uncertainty for the stored entry to be updated using a set of one or more other stored entries meeting the first criteria; and
storing the updated computation result and the computation uncertainty as the updated stored entry.

A stored entry to be updated may be identified based on at least one of: a time from the previous update, information indicating the source of the stored entry, the stored uncertainty measure or one or more stored distance measures.

In an embodiment, the method further comprises:
identifying a plurality of stored entries to be updated, determining an updated computation result and a computation uncertainty for each of the stored entries to be updated using a set of one or more other stored entries meeting the first criteria, and storing the updated computation results and the computation uncertainties as the updated stored entries, and/or
obtaining a plurality of inputs, for each of the plurality of inputs: determining a distance measure between the input and each of a plurality of stored entries;

determining if a stored entry meets the first criteria; if a stored entry meets the first criteria, determining a computation result and a computation uncertainty for the input using a set of one or more stored entries meeting the first criteria; and storing the input, the computation result and the computation uncertainty as a stored entry;
wherein the computation results for the plurality of inputs and/or the plurality of stored entries are determined in a combined calculation.

In an embodiment, the method further comprises:
determining whether the first computation result meets a third criteria, wherein the third criteria is based on the computational uncertainty;
if the estimated result does not meet the third criteria, performing calculation of a full computation; and
if the estimated result does meet the third criteria, storing the first input, the first computation result and the first computation uncertainty as the first stored entry.

In an embodiment, the method further comprises deleting one or more stored entries based on a distance measure, the computational result and/or the uncertainty.

In an embodiment, the first criteria comprises a first condition that the distance measure for the stored entry meets a first threshold and a second condition that the stored uncertainty measure for the stored entry meets a second threshold.

In an embodiment, the method further comprises storing the distance measures.

In an embodiment, the method further comprises determining if the first computation result meets a sixth criteria, wherein the sixth criteria is based on the distance measure or the first computation uncertainty, and if the first computation result meets the sixth criteria, storing the first stored entry as a new entry.

In an embodiment, the method further comprises determining if the first computation result meets a seventh criteria, wherein the seventh criteria is based on the distance measure or the first computation uncertainty, and if the first computation result meets the seventh criteria, storing the first input, the first computation result and the first computation uncertainty as a first stored entry comprises updating a first stored entry.

In an embodiment, the first set of one or more stored entries is selected by applying one or more conditions, including one or more of: that the first set has a maximum number of stored entries, that the first set has a minimum of stored entries, that the first set does not comprise any stored entries within a pre-determined distance of each other, or that the first set does not comprise any stored entries within a pre-determined distance of the first entry.

In an embodiment, the first input data and the stored data comprise image data. The computation result may be an indication of whether a feature is detected in the image.

According to an embodiment, there is provided a computer implemented method, comprising:
obtaining a first input;
determining a distance measure between the first input and each of a plurality of stored entries, each of the plurality of stored entries comprising a stored input, a stored output and a stored uncertainty measure;
determining if a stored entry meets a first criteria, wherein the first criteria is based on the distance measure and the stored uncertainty measure;
if a stored entry meets the first criteria, determining a first output and a first computation uncertainty for the first input using a first set of one or more stored entries meeting the first criteria; and
storing the first input, the first output and the first computation uncertainty as a first stored entry.

According to an embodiment, there is provided a computer implemented method of obtaining a computation result, comprising:
obtaining a first input;
determining a distance measure between the first input and each of a plurality of stored entries, each of the plurality of stored entries comprising a stored input, a stored computation result and a stored uncertainty measure;
determining if a stored entry meets a first criteria, wherein the first criteria is based on the distance measure and the stored uncertainty measure; and
if a stored entry meets the first criteria, determining a first computation result and a first computation uncertainty for the first input using a first set of one or more stored entries meeting the first criteria.

In an embodiment, the method further comprises determining if the first computation result meets a criteria, and if the first computation result meets the criteria, storing the first input, the first computation result and the first computation uncertainty as a first stored entry.

According to an embodiment, there is provided a system comprising:
an input configured to receive a first input;
an output configured to provide a computation result;
a memory configured to store a plurality of stored entries;
one or more processors configured to:
   determine a distance measure between the first input and each of a plurality of stored entries, each of the plurality of stored entries comprising a stored input, a stored computation result and a stored uncertainty measure;
   determine if a stored entry meets a first criteria, wherein the first criteria is based on the distance measure and the stored uncertainty measure;
   if a stored entry meets the first criteria, determine a first computation result and a first computation uncertainty for the first input using a first set of one or more stored entries meeting the first criteria; and
   store the first input, the first computation result and the first computation uncertainty in the memory as a first stored entry.

According to an embodiment, there is provided a carrier medium comprising computer readable code configured to cause a computer to perform any of the above described methods.

According to an embodiment, there is provided a non-transitory computer readable storage medium comprising program instructions stored thereon that are executable by a computer processor to perform any of the above described methods.

The methods are computer-implemented methods. Since some methods in accordance with embodiments can be implemented by software, some embodiments encompass computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal. The carrier medium may comprise a non-transitory computer readable storage medium. According to a further aspect, there is provided a carrier medium comprising computer readable code configured to cause a computer to perform any of the above described methods.

Memoization is a technique used to improve computational efficiency. Memoization comprises storing results of computationally expensive functions in a cache, and returning the cached result when the same inputs are received in future. In this way, performing the full computation of the function can be avoided for a new input which is the same as a previous input. Instead, the cached result corresponding to the previous input is retrieved and returned. By employing such a technique, computer programs comprising one or more complex functions may be performed more quickly and using less computational resource. Memoization can be used to speed up calculations by storing the results of previous computations in a cache and returning the cached result when the same inputs are received.

Although such a technique provides improved efficiency when the same inputs are received, when new inputs are received, the full calculation is still performed. Thus computational efficiency gains are limited.

As explained in relation to methods described herein, a distance measure between a new input and the stored inputs corresponding to the previous stored results is determined. It is then determined if any stored results meet a first criteria based on the distance measure and stored uncertainties of the stored results. A computation result is then estimated from a first set of stored computation results which meet the first criteria. The first set of stored computation results are near to the new input and are used to estimate a computational result for the new input, without requiring performance of the full function. This provides improved computational efficiency. This estimated computation result is then stored together with a computation uncertainty. This stored estimated computation result can be used to determine a future computation result for a future input, thus further reducing the need for performance of the full calculation for future inputs.

In these methods, a memoization system is modified to include function estimation. A memoization function cache is provided, allowing storing and retrieving of previous inputs and their associated outputs (computational results). For a new input, where a first criteria is satisfied, a result is estimated from prior results in a network calculation which can be implemented using one or more matrix calculations.

Nodes in the network correspond to inputs and outputs. Connection weights in the network are a function of node distance. In this way, computational resources may be managed efficiently when executing computationally expensive functions. For example, as the cache is filled with stored entries, more and more function calls may either return a result retrieved directly from memory or estimated using one or more matrix operations. The computational cost of such operations is highly predictable, and does not depend on the complexity of the full function. Furthermore, such operations are scalable and optimizable for performance on hardware comprising multiple CPUs, and/or one or more CPUs and/or other clusters of processors for example.

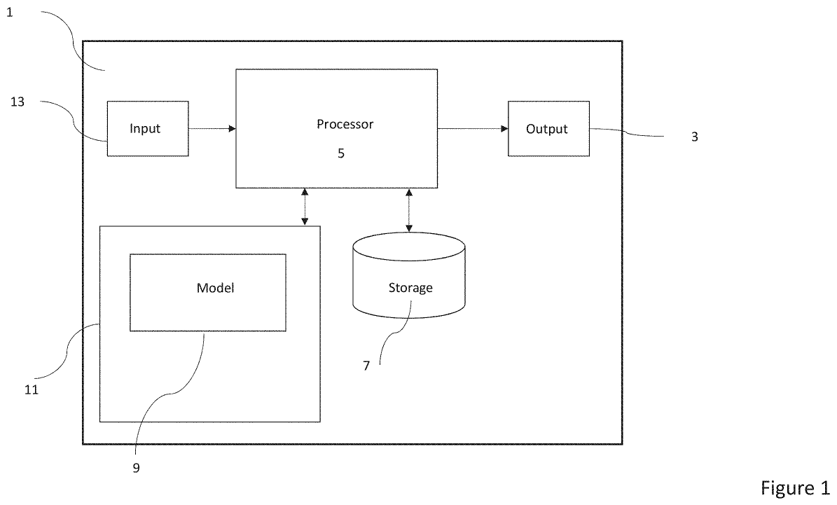

FIG. 1 is a schematic illustration of a system 1 in accordance with an embodiment. The system comprises an input 13, a processor 5, a working memory 11, an output 3, and storage 7. The system 1 may be a mobile device such as a laptop, tablet computer, smartwatch, or mobile phone for example. Alternatively, the system 1 may be a computing system, for example an end-user system that receives inputs from a user (e.g. via a keyboard, screen or microphone) and provides output (e.g. via a screen or speaker), or a server that receives input and provides output over a network.

The processor 5 is coupled to the storage 7 and also accesses the working memory 11. The working memory 11 or RAM is communicatively coupled to the processor 5. The processor 5 may comprise logic circuitry that responds to and processes the instructions in code stored in the working memory 11. In particular, when executed, a model 9 is represented as a software product stored in the working memory 11. Execution of the model 9 by the processor 5 will cause methods as described herein to be implemented.

The processor 5 also accesses an input module 13 and the output module 3. The input and output modules or interfaces 13, 3 may be a single component or may be divided into a separate input interface 13 and a separate output interface 3. The input module 1 receives a target input through an input, which may be a receiver for receiving data from an external storage medium or a network, a microphone, screen or a keyboard for example. The output module 3 provides the result generated by the processor 5 to an output such as a speaker or screen, or a transmitter for transmitting data to an external storage medium or a network for example.

The storage 7 is communicatively coupled to the processor 5. The storage 7 comprises non-volatile memory which may include any form of non-volatile device memory such as flash, optical disks or magnetic hard drives for example. The storage 7 contains data that is used by the model 9 when executed by the processor 5, including the node cache and connection cache described in relation to the methods below. As illustrated, the storage 7 is local memory that is contained in the device. Alternatively however, the storage 7 may be wholly or partly located remotely, for example, using cloud based memory that can be accessed remotely via a communication network (such as the Internet). The model 9 is stored in the storage 7. The model 9 is placed in working memory 11 when executed. In many cases the working memory 11 of a device is limited. Data that is used by the model 9 when executed by the processor 5 may also be transferred to the working memory 11. For example, the node cache and connection cache may be transferred to working memory 11 at the start of a processing session and then written back to storage 7 at the end of a session.

As illustrated, the system 1 comprises a single processor 5. However, the model 9 may be executed across multiple processing components, which may be located remotely, for example, using cloud based processing. For example, the system 1 may comprise at least one graphical processing unit (GPU) and a general central processing unit (CPU), wherein various operations described in relation to the methods below are implemented by the GPU, and other operations are implemented by the CPU. For example, matrix operations or vector operations are performed by the GPU. Examples of operations that may be performed more efficiently by the GPU are described below. Each of the CPU and GPU may have corresponding working memory. Although a GPU is described here as an example, various operations may additionally or alternatively be performed by multiple CPUs, cores and/or other clusters of one or more processing components which are configured for parallel operation for example.

Usual procedures for the loading of software into memory and the storage of data in the storage unit 7 apply. The model 9 can be embedded in original equipment, or can be provided, as a whole or in part, after manufacture. For instance, the model 9 can be introduced, as a whole, as a computer program product, which may be in the form of a download, or can be introduced via a computer program storage medium, such as an optical disk. Alternatively, modifications to existing dialogue manager software can be made by an update, or plug-in, to provide features of the above described embodiment.

While it will be appreciated that the above embodiments are applicable to any computing system, the example computing system illustrated in FIG. 1 provides means capable of putting an embodiment, as described herein, into effect.

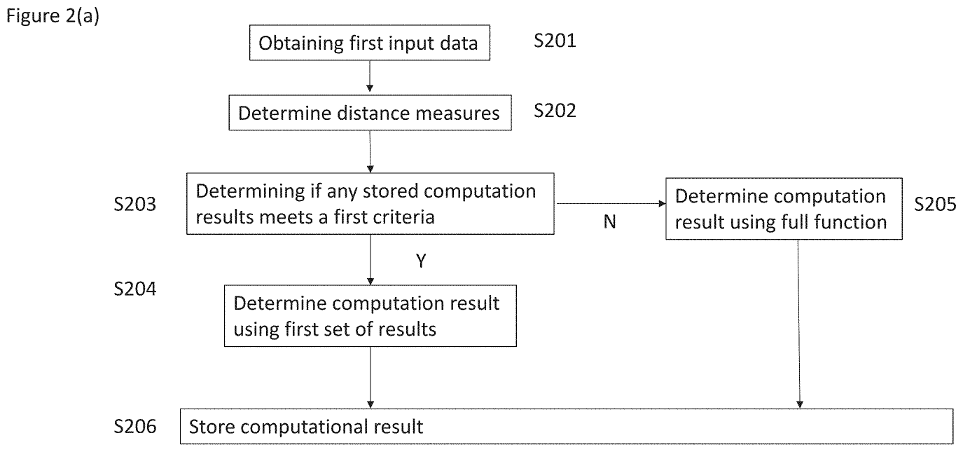

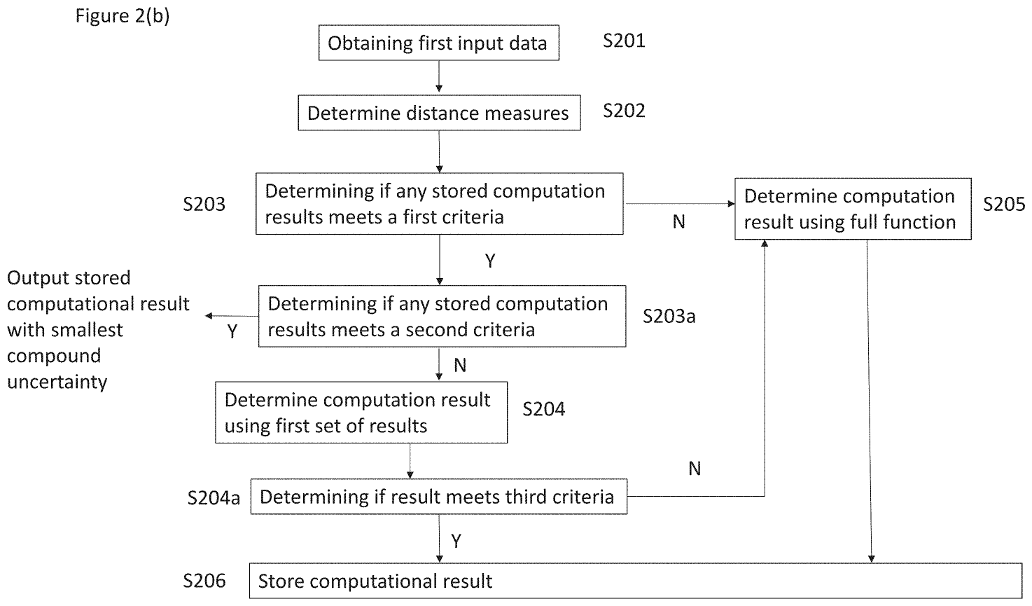

FIG. 2(a) is a schematic illustration of a method according to an embodiment. The method may be performed on a system such as has been described in relation to FIG. 1. The method is a method of obtaining a result of a computation. In the example described here, the full computation is a function f. The input of the function is a four dimensional vector of the form (a, b, c, d), where a, b, c and d are continuous values between 0 and 1. The output of the function is a single continuous value. The function f may be computationally expensive to perform for example.

The method comprises a first step, S201, of obtaining first input data. The first input data is also referred to here as the target input and as z. In the example described here, the target input z is a 4-dimensional vector, (1, 1, 1, 1). The target input in this example is provided by a user. In this step, a function request for the computational result of the function f for the input z is received from the user.

In S202, a step of determining a distance measure between the first input data and each of a plurality of stored entries is performed. Each stored entry comprises a stored input, a stored computation result and a stored uncertainty measure. The entries are stored in a memoization function cache, also referred to as here as the node cache. The node cache may be in the form of a table, which is stored in the storage 7.

In this example, three inputs, x₁, x₂, and x₃, are stored. These correspond to cached or stored entries. For example, the stored input x₁ in this simple example is (1, 1, 1, 0).

Each stored input data has a corresponding computation result. In other words, the results of the function f for each of the inputs x₁, x₂, and x₃, are stored. These are referred to as the stored outputs or stored computation results, y₁, y₂, and y₃. Each stored computation result also has a corresponding stored uncertainty measure uₛ where s identifies the stored entry. The stored uncertainty measures in this example are referred to as u₁, u₂, and u₃.

In this step S202, a distance measure between stored input x₁ and target input z is determined, a distance measure between stored input x₂ and target input z is determined, and a distance measure between stored input x₃ and the target input z is determined. The distance measure between z and x₁ is referred to as Δz,x₁and so on.

In this example, the distance measure is a Normalised Manhattan Distance. The distance measure determination returns a result between 0 and 1, with 0 indicating that the two inputs are identical and 1 indicating that they are completely different. A distance measure nearer to 0 indicates that the two inputs are nearer to each other. The distance measure between z and x₁, referred to as Δz,x₁, is calculated as 0.25, and so on. In this step, the distance measures between target input z and each of the stored inputs x₁, x₂ and x₃ are calculated. Note that a distance measure may equally be given by {1—Normalised Manhattan Distance} for example, in which case a distance measure closer to 1, i.e. a larger distance measure, indicates higher similarity.

In step S203, it is determined if any stored computation results meets a first criteria. The first criteria is based on the distance measure.

The first criteria comprises a first condition that the stored entry is near to the target input. For example, the first condition does not require that the stored entry is identical to the target input, rather, the first condition requires that the stored entry and the target entry are within a certain similarity (which would include identical entries). For example, the first criteria comprises a first condition that the distance measure meets a first threshold. In this example, the first criteria specifies that the stored result has a distance measure less than a first threshold value. The first threshold value is greater than 0. The first threshold value is 0.5 for example.

The first criteria further comprises a second condition that the stored uncertainty meets a second threshold. In this example, the first criteria further specifies that the stored result has a stored uncertainty less than or equal to a second threshold value. The second threshold value is 0.5 for example. The first threshold value and the second threshold value may be the same or different for example.

Step S203 may be performed by implementing a first step, in which the stored entries are searched to determine stored entries for which the first condition is satisfied. Spatial partitioning based techniques can be used to improve efficiency of this step. A set of stored entries for which the first condition is satisfied are then searched to determine stored entries for which the second condition is satisfied.

If none of the stored computation results meet the first criteria, a computation result is then determined by performing the full computation, in other words by performing the function f on the new input, in S205. The result of this computation is the first computation result in this case. The first computation result is returned as the output. It is stored in the cache in a first entry in S206. The first entry comprises the first input, the first computation result and a stored uncertainty measure. The uncertainty measure may be set to zero in cases where the full function f has been performed. Alternatively, the full function f may have some associated uncertainty, which is stored as the stored uncertainty measure. The computation result may also be returned as the output, for example via a screen to the user.

If a stored computation result does meet the first criteria, step S204 is performed, which comprises determining a first computation result and a first computation uncertainty for the first input using a first set of one or more stored entries meeting the first criteria. The first set may comprise all of the stored computation results meeting the first criteria which were found in S203. The first set may also be referred to as the “relevant results” and as the “contributing nodes”.

There may be a minimum number of stored computation results for the first set, for example two. If the minimum number is not met, the full computation may be performed in S205 as described above.

Additionally or alternatively, there may be a maximum number of stored results associated with the first set. For example, where more than n results are found, the n stored results having the smallest distance measure are selected to form the first set, where n is a pre-determined positive integer.

Other conditions may be applied when generating the first set, for example that the first set does not comprise any stored entries within a pre-determined distance of each other, and/or that the first set does not comprise any stored entries within a pre-determined distance of the target entry.

The computation result is calculated in S204 as a weighted combination of the first set of stored results. In this example, the weights are determined based on a compound uncertainty value. In this example, the weight corresponding to a stored result is calculated as 1 divided by the compound uncertainty calculated for the stored result. The compound uncertainty for the output at x₁ adjusted for what it would be at z is referred to as u_{z,1}. In this example, the compound uncertainty is calculated as u_{z,1}=(u₁)(Δz,x₁)+u₁+Δz,x₁. The compound uncertainty in this example is calculated by combining the stored uncertainty measure u₁ of the stored computation result y₁ with the distance measure Δz,x₁ between the target input z and the stored input x₁. The compound uncertainty is calculated for each stored input in the first set. The compound uncertainty is calculated based on the distance and the uncertainty measure of the stored input.

In this example, the estimated computation result is calculated as a weighted mean of the first set of stored results. Each stored result in the first set is multiplied by the corresponding weight. A sum is taken of the weighted stored results, and the summed result divided by the sum of the weights to give the output value.

In this example, the weight corresponding to the first stored result is calculated from:

$${w}_{1} = \frac{1}{{u}_{z , 1}} \qquad ( 1 )$$

The computation result is calculated as the weighted mean of the stored results:

$$\hat{y} = \frac{{\sum }_{i = 1}^{n} {y}_{i} {w}_{i}}{{\sum }_{i = 1}^{n} {w}_{i}} \qquad ( 2 )$$

where n is the number of results in the first set, which may vary for each input or be fixed, as described above. A computation uncertainty of the output result may also be calculated from:

$$\hat{u} = \frac{{\sum }_{i = 1}^{n} {y}_{i}}{{\sum }_{i = 1}^{n} {y}_{i} {w}_{i}} \qquad ( 3 )$$

The relationship in Equation (3) is based on consideration of the expected error range for the computation result ŷ. The expected error range, based on the absolute error, of ŷ is:

$$\pm \frac{{\sum }_{i = 1}^{n} ( {u}_{z , i} ) {y}_{i} {w}_{i}}{{\sum }_{i = 1}^{n} {w}_{i}} = \frac{{\sum }_{i = 1}^{n} {y}_{i}}{{\sum }_{i = 1}^{n} {w}_{i}}$$

The relative error of ŷ is thus given by:

$$\frac{\frac{{\sum }_{i = 1}^{n} {y}_{i}}{{\sum }_{i = 1}^{n} {w}_{i}}}{\frac{{\sum }_{i = 1}^{n} {y}_{i} {w}_{i}}{{\sum }_{i = 1}^{n} {w}_{i}}} = \frac{{\sum }_{i = 1}^{n} {y}_{i}}{{\sum }_{i = 1}^{n} {y}_{i} {w}_{i}}$$

Although a specific function is described in Equation (3) above, there are various functions that could be used to calculate the output computation uncertainty. For example, the relationship in Equation (3) may have additional parameters based on the number of stored entries used in the calculation (i.e. the number of stored entries in the first set n), where more contributing nodes (higher n) results in reduced uncertainty. Additionally or alternatively, parameters based on the standard deviation of the contributing n nodes may be included in Equation (3), where smaller standard deviation reduces uncertainty.

In this example, the first set of stored computation results are inputs of a first network, wherein the first network computes a weighted combination of the first set of stored computation results. The network is constructed by looking up relevant data from the node cache. A set of stored computation results where the first criteria is met are retrieved. These are the first set of results as described above. These stored results provide the input nodes for the function estimation.

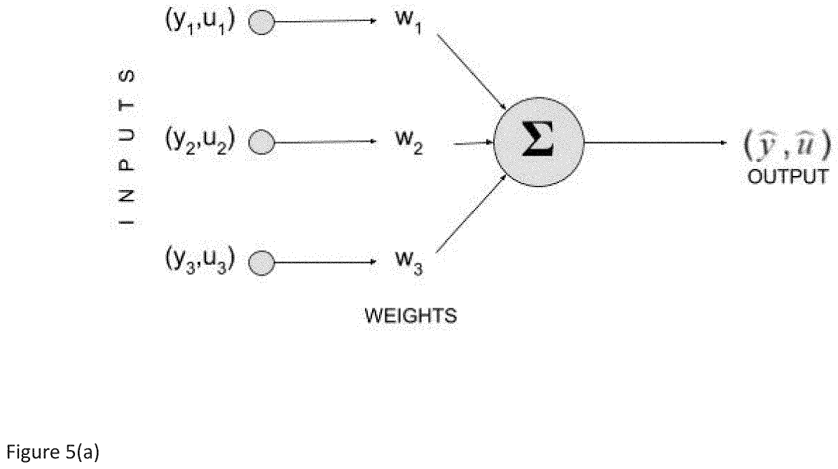

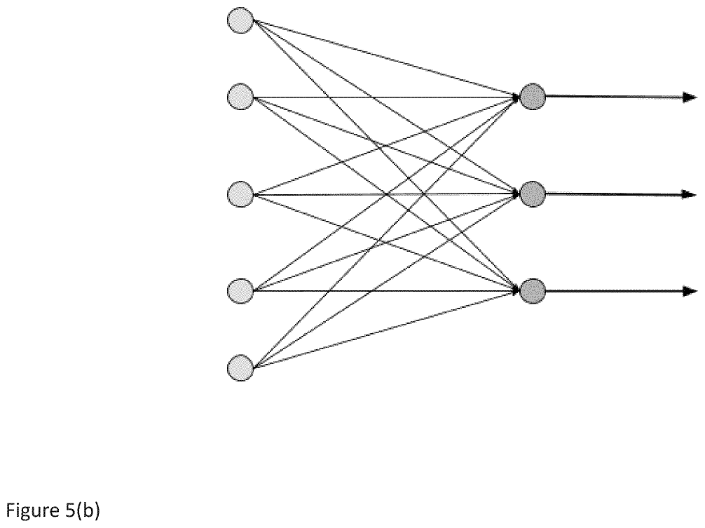

FIG. 5(a) shows an example network. In this example, there are three relevant input nodes from the cache which meet the first criteria. The input nodes correspond to the stored outputs, y₁, y₂, and y₃. The output node corresponds to the output computation result for the target input. The network propagates the results corresponding to the stored nodes as inputs to the estimation function. The estimation function here is a weighted mean, as described above. This generates a combined estimated output for the target input.

The calculation of the term Σᵢ₌₁ⁿyᵢwᵢ, which is used to determine the estimated computation result and the computation uncertainty as shown in equations (2) and (3) above, can be implemented as a single matrix calculation:

$$[ {w}_{1} … {w}_{n} ] [ \begin{matrix}{y}_{1} \\ ⋮ \\ {y}_{n}\end{matrix} ]$$

A single matrix calculation can be performed for this term, and the result used in both the determination of the computation result and the computation uncertainty.

Furthermore, where multiple target inputs are taken, the terms Σᵢ₌₁ⁿyᵢwᵢ can be calculated in parallel for the target inputs, by implementing the following matrix calculation, where m is the number of target inputs:

$$[ \begin{matrix}{w}_{1 , 1} & … & {w}_{1 , l} \\ ⋮ & ⋱ & ⋮ \\ {w}_{m , 1} & … & {w}_{m , l}\end{matrix} ] = [ \begin{matrix}{y}_{1} \\ ⋮ \\ {y}_{l}\end{matrix} ] [ \begin{matrix}{{\sum }_{i = 1}}^{l} {y}_{i} {w}_{1 , i} \\ ⋮ \\ {\sum }_{i = 1}^{l} {y}_{i} {w}_{m , i}\end{matrix} ]$$

In this equation l is the number of stored entries used in the calculation. For example, l may be the superset of the stored entries from the m first sets that are being processed together. Alternatively for example, l may be the total number of entries in the cache. Where a particular stored entry yᵢ is not part of the first set for a particular target input j, the weight w_{j,i} is set to 0. In the above, the weight w_{j,i} is 1/u_{j,i}, where u_{j,i} is the compound uncertainty for the stored entry i and the target input j.

The matrix calculation of the term Σᵢ₌₁ⁿyᵢwᵢ is the most computationally expensive part of the determination of the computation result and of the computation uncertainty. By performing this as a single matrix calculation for both determinations and for all target inputs, further computational efficiency can be obtained.

The first set of stored entries may not be the same for all the m target inputs. However, the matrix calculation comprises all of the entries in the cache, where the weights are set to zero for any stored entries not included in the first set for the target input. The output results for each target input can be calculated using a single matrix multiplication, multiplying the weights matrix and the input matrix (of stored results). Such a case is shown in FIG. 5(b), where outputs for three different target inputs are calculated using the same network. In this case, the m target inputs share the same first set.

The matrix calculation described above can be implemented on hardware such as a Graphical Processing Unit (GPU). The network weights form a first matrix. The stored results in the cache form a second matrix. The product of the first matrix and second matrix is taken. This operation may be performed more efficiently on a GPU. The same function is performed at each of many nodes in the network. This means that parallel processing can be used to improve performance. Thus the stored computation results and compound uncertainties are passed from a CPU to a GPU, and calculation of the estimated computation result and estimated uncertainty using the network is performed at the GPU. The estimated computation is then passed back to the controlling process in the CPU for storage in the cache and output.

Step S204 is performed using a function estimation engine. The function estimation engine receives a request for an output computation result for a first input z. The generated computational result and computational uncertainty are stored and may be used by the estimation engine in future estimations. The computational uncertainty allows the estimation engine to determine to what extent the stored computational results can be attributed to new inputs.

As described above, in some cases, requests for computational results for two or more target inputs may be processed at the same time. These requests may be processed using shared matrix calculations as described above. Systems comprising multiple CPUs, and/or one or more CPUs and/or other clusters of processors can be used to increase performance in such cases. The network can operate with a high degree of concurrency with many parallel client processes.

An output is calculated for a target input, with a corresponding computation uncertainty. The result is then stored as a first stored entry in S206. The first stored entry comprises the first input, the first computation result and the first computation uncertainty. The first computation uncertainty is stored in the first stored entry as the stored uncertainty measure. The computation result may also be returned as the output, for example via a screen to the user. In addition, the distance measures can be stored in a connection cache (or distance matrix).

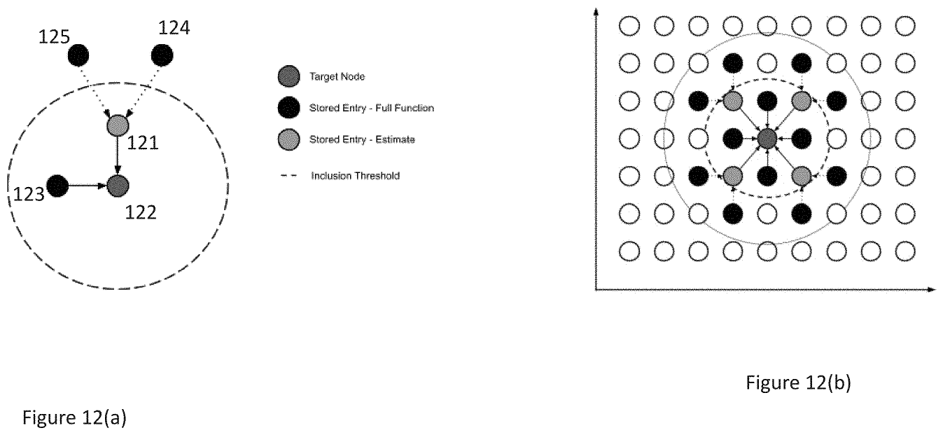

As shown in FIG. 12(a), the first stored entry 121 calculated in S204 as described above may meet the first criteria for a future input 122. FIG. 12(a) shows the case where a further input 122 is received, shown at the centre of the circle in the figure. The process described above in relation to FIG. 2(a) is performed in relation to the further input 122. The dashed circle illustrates the first condition of the first criteria, i.e. the distance measure threshold. For this illustration, we assume that all stored entries meet the second condition of the first criteria, i.e. the uncertainty threshold. As can be seen, two stored entries meet the first criteria. One of these corresponds to a computation result 123 previously generated by running the full function. The other is a first stored entry 121, which comprises the first input, the first computation result and the first computation uncertainty calculated in S204 in the process described above. This first entry 121 was calculated in S204 in the process described above from the stored entries 124 and 125 (corresponding to previously generated full function results). The two further stored entries 124 and 125 do not meet the first criteria for the further input 122, but do meet the first criteria for the first entry 121.

By storing the estimated computation results such as the first entry 121 in the cache together with the computation uncertainty, it is more likely that for a future input, there will be stored results that meet the first criteria. It is therefore more likely that a result can be estimated in S204 instead of running the full computation.

Furthermore, by calculating the result for the future input 122 shown in FIG. 12(a) using the stored estimate 121 nearer the target node, an equivalent accuracy can be obtained as for calculating the result for the future input 122 from the stored full function entries 123, 124 and 125. However, the estimation based on the stored estimate 121 is more efficient. The entry 121 stores combined information from entries 124 and 125 which is reused in the calculation of nearby target inputs without needing to repeat the combination. The use of estimates nearer the target node results in equivalent accuracy with increased efficiency. In other words, by storing previous estimated entries, a first criteria may be chosen which encompasses a smaller “area”, as shown in FIG. 12(b). In the example described above, a first criteria having a lower threshold distance measure may be chosen, meaning that results may be obtained with fewer calculations. FIG. 12(b) illustrates the memoization of a function with two input dimensions. For functions with higher dimensionality, the degree of computational efficiency gained by using estimates in the inner region (corresponding to a lower distance threshold) is amplified.

FIG. 2(b) is a schematic illustration of a method according to an alternative embodiment. The method may be performed on a system such as has been described in relation to FIG. 1. The method is similar to that described in FIG. 2(a). Additional steps S203a and S204a are performed. The other steps are the same as those described in relation to FIG. 2(a) above. Although both additional steps S203a and S204a are described, it is understood that the method may be performed with additional step S203a but without additional step S204a, or with additional step S204a but without additional step S203a.

In S203a, it is determined if any stored computation results meets a second criteria. In this example, the second criteria is whether the distance measure meets a third threshold. For example, the second criteria is that the distance measure is less than or equal to a third threshold value. The third threshold value may be greater than or equal to zero. The third threshold value is less than the first threshold value. For example, the third threshold value is 0.1. Alternatively, the second criteria is that the distance measure is zero. This step may be implemented by finding the lowest distance measure, and determining if the lowest distance measure is less than 0.1.

If one or more stored computational results meet the second criteria, the computation result corresponding to the smallest distance measure is provided as the output. In other words, the stored computational result corresponding to the smallest distance measure is provided as the computation result for the new input.

In this step, it is determined if any stored entry is the same as, or very near to (i.e. nearer than the first condition) the target input. In this way, the result of a stored input is simply returned in cases where the new input is the same as, or very near to, a stored input. This provides improved computational efficiency, since performance of the weighted combination calculation is avoided in such cases.

Although in this example, the second criteria is based on the distance measure only, the second criteria may alternatively be based on both the distance measure and the uncertainty of the stored computation results, in a similar manner to the first criteria. Alternatively, the second criteria may be that the compound uncertainty is less than or equal to a threshold value. If one or more stored computational results meet the second criteria, the computation result corresponding to the smallest compound uncertainty is provided as the output in this case.

Each stored result meeting the first criteria may be checked against the second criteria. If one or more stored computational results meet the second criteria, the computation result corresponding to the smallest distance measure, or the smallest compound uncertainty for example, is provided as the computational result.

If none of the stored computation results meet the second criteria, a computation result is then determined in S204 as described above.

Step S204a comprises determining whether the estimated result meets a third criteria. For example, it may be determined if the computational uncertainty is less than a threshold. If the estimated result does not meet the third criteria, then calculation of the full function f with the target input is performed in S205 as before. The computational uncertainty may therefore also be used to assess whether a full function call is used. In step S204a, if the estimated result does meet the third criteria, the result is then stored as a first stored entry in S206 as before. The first stored entry comprises the first input, the first computation result and the first computation uncertainty.

In the above described examples, the first input corresponds to a new input (i.e. an input for which a stored entry does not already exist). In step S206, a new stored entry is created and the first input, first computation result and first computational uncertainty are stored in the new stored entry. Various additional conditions may be applied to determine whether to store the new entry, such as distance from other entries for example. For example, it is determined if the new entry meets a sixth criteria, where the sixth criteria is whether the distance measure meets a threshold for example. Alternatively however, the target input may be an input for which a stored entry already exists. In this case, the computation result and computational uncertainty of the existing stored entry are updated in S206. Again, various additional conditions may be applied to determine whether to make the update, for example that the computation uncertainty is less than the existing stored uncertainty. For example, it is determined if the new entry meets a seventh criteria, where the seventh criteria is that the computation uncertainty is less than the existing stored uncertainty.

In the above described example, a compound uncertainty is calculated as u_{z,1}=u₁Δz,x₁+u₁+Δz,x₁. The compound uncertainty is then used to generate the weights, which in turn are used in S204 to determine the computation result. How this compound uncertainty function is derived will now be described. As described above, a first stored entry has a stored input x₁, a stored computation result y₁, and a stored uncertainty u₁. The result for the first stored entry can therefore be considered to be: y₁+/−(u₁*y₁). An estimate for the target input z based on the stored entry can therefore be considered to be: {the result for the stored entry}+/−{the result for the stored entry*d}, where d is used here to denote the distance between the target input and the stored entry (which is Δz,x₁ for the stored entry x₁). This is given by: y₁+/−(u₁*y₁)+/−(y₁+/−(u₁*y₁))*d, again where d=Δz,x₁. The maximum predicted value for the target input is therefore y₁+(u₁*y₁)+(y₁+(u₁*y₁))*d=y₁+(u₁*y₁)+(d*y₁)+(d*u₁*y₁)=y₁+y₁ (u₁+d+(d*u₁)). The predicted error, or compound uncertainty, is therefore u₁+d+(d*u₁).

The above assumes a linear relationship between distance and uncertainty, u=d. For the more general case, an estimate for the target input z based on the stored entry can be given by {the result for the stored entry}+/−{the result for the stored entry*g(d)}, where g is some function of d. This is given by: y₁+/−(u₁*y₁)+/−(y₁+/−(u₁*y₁))*g(d), where d=Δz,x₁. The maximum predicted value for the target input is therefore y₁+(u₁*y₁)+(y₁+(u₁*y₁))*g(d)=y₁+(u₁*y₁)+(g(d)*y₁)+(g(d)*u₁*y₁)=y₁+y₁(u₁+g(d)+(g(d)*u₁)). The predicted error, or compound uncertainty, is therefore u₁+g(d)+(g(d)*u₁). Such a compound uncertainty function can be used in the processes described above in place of the described compound uncertainty function. The function g may be a linear function, such as a +bd, or a non-linear function. The function g(d) may be selected as a monotonic function of d.

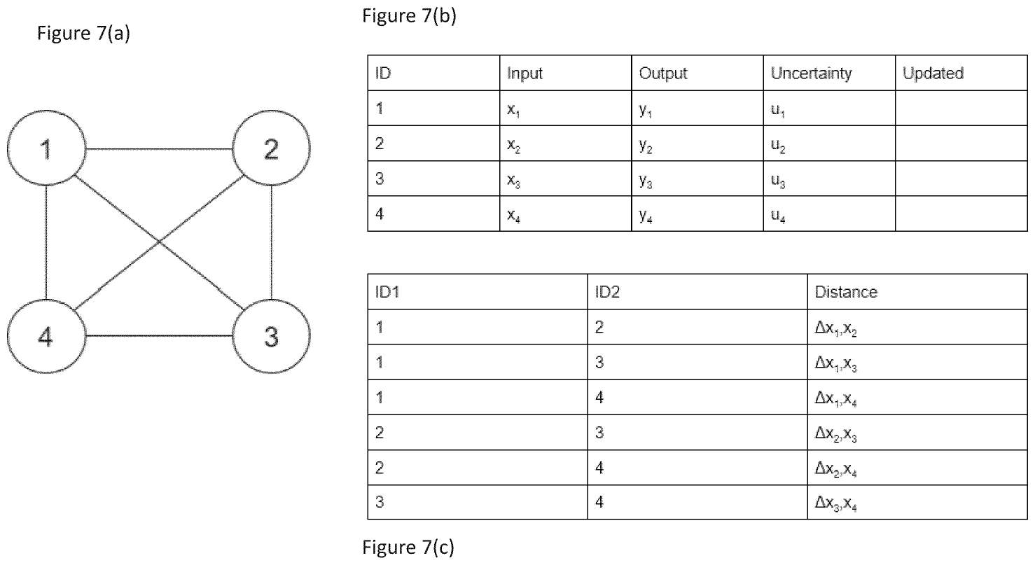

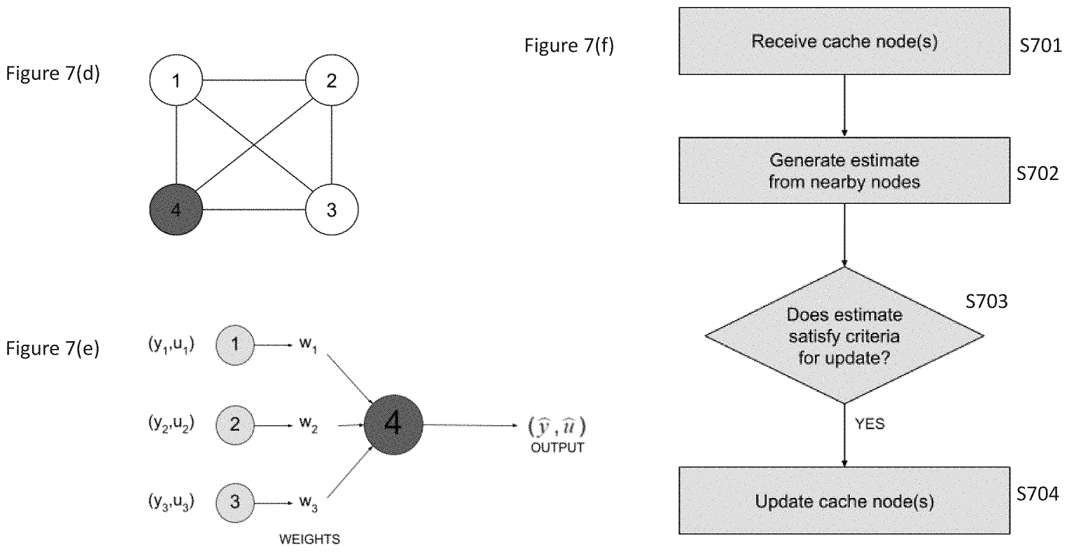

In the above described methods, a table, also referred to here as a “distance matrix” or “connection cache” may be used to store and retrieve the network relationships between stored entries and the distance measures between them. FIG. 7(a) shows a schematic illustration of four stored entries in a cache, represented as nodes. FIG. 7(b) shows a schematic illustration of the information stored in the node cache, comprising an ID for each stored entry, the input, the computation result (output) and the uncertainty measure. FIG. 7(c) is a schematic illustration of the connection cache, which stores the distance measures between each of the stored entries. The distance measures stored in the connection cache can be used to optimize the retrieval of stored entries. For example, in S203 described above it is determined if any of the stored entries meet the first condition of the first criteria, namely that the distance measure to the target input is less than a threshold. The connection cache can be used in this step. Spatial partitioning techniques such as k-d tree based methods can be used to optimize the distance based retrieval of the first set for example. Spatial partitioning techniques are generally optimizable using GPU devices.

In S202, a step of determining a distance measure between the first input data and each of a plurality of stored entries is performed. The distance measures may be determined for all stored entries in the cache. The distance measures are computed and inserted into the connection cache before or at the same time as the new entry is inserted into the node cache. If, for any reason, one or more distance measures are not inserted at this point, for example because a spatial partitioning algorithm was used to determine entries meeting the first criteria, the distance measures can be calculated or updated in the connection cache at any later stage.

Optionally, one or more of the stored results may be updated based on the other stored results. For example, this may be performed at regular intervals, or may be triggered by another process such as an update to the cache, or at a user request. The one or more stored results to be updated may be those with an update date/time greater than a pre-determined amount of time ago for example. Entries to be updated may be identified based on one or more of: a time from the previous update, information indicating the source of the stored entry, the stored uncertainty measure or one or more stored distance measures. The information indicating the source of the stored entry may be an identification of the method used to generate the computation result, or an identification of the system or user from which the computation result was received for example.

FIGS. 7(d), (e) and (f) illustrate a process of re-processing the fourth stored entry based on the first, second and third stored entries. In step S701, the identification of the entry to be updated is received. In this case, the fourth stored entry is identified. The identification may be based on the information in the node cache indicating the previous updated time for example. In S702, an updated computation result and computation uncertainty for the fourth entry is generated from a first set of stored entries, as described in relation to S204 above. In this case, each of the first, second and third stored entries are included in the first set, as shown in FIG. 7(e). In S703, it is determined whether the updated computation result and/or the computation uncertainty meet an seventh criteria. For example, the seventh criteria is that the computation uncertainty is less than the existing stored uncertainty. Alternatively, the seventh criteria is that the particular user has permission to update the cache. In S704, if the seventh criteria is met, the result (output) and uncertainty measure for the fourth node is updated in the cache.

Optionally, the process of generating the first set and generating an estimate can be repeated. There may be a number of parallel processes accessing the cache at the same time. In other words, multiple requests for output results for different target inputs may be received and processed at the same time. Given this, scenarios will arise in which more nodes are added to the cache which would satisfy the first and/or second criteria for calculation of a target input (or for an entry to be updated) which has already been calculated. Furthermore, some stored inputs may have received an updated result, for example with lower uncertainty. Repeating the process for a target input (or entry to be updated) can therefore yield more accurate estimates at each iteration. This is referred to as a network recursion.

Optionally, new entries with specific input values can be added to the cache to at any stage. For example, new entries may be added for which the computational results are determined by running the full function. Where the computational results are determined by running the full function, a stored uncertainty value of zero may be given. This improves the efficiency of the system by increasing the chances of future target inputs having an exact match for example, and also increases the accuracy of future estimations. This may be a background process to be run during server downtime for example. This process may be performed by including new entries with a specified distance measure from existing entries for example, to ensure a specific population density within the cache. This is achieved by specifying that the new entry must be a minimum and maximum distance from all other entries. If the resulting entry would not satisfy this distance relationship (as determined during the process of population), the new cache entry is discarded. If the stored entry already exists for the requested addition, the existing stored entry may be updated.

New entries may also be added where the computational result has already been determined, for example by some other process or system. The process of adding new nodes with pre-determined outputs is also referred to as pre-populating the cache.

Furthermore, redundant and/or suboptimal nodes can be removed from the cache. This may again be a background process to be run during server downtime.

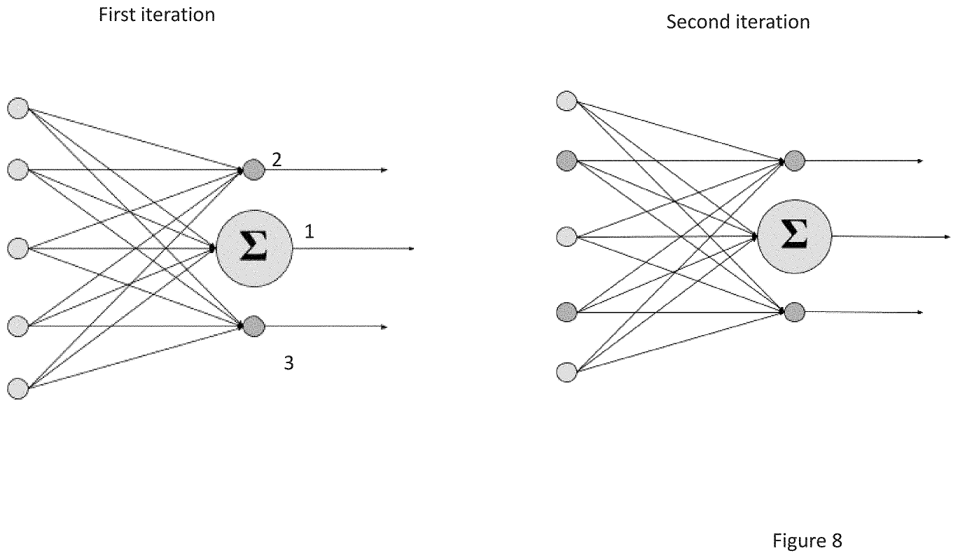

FIG. 8 is a schematic illustration of a method according to an embodiment, in which, in parallel with calculating the output result for a target input in S204, one or more stored entries are updated. These additional output nodes correspond to a second set of stored inputs which meet a fourth criteria. The fourth criteria may be based on distance measure or compound uncertainty for example. For example, the second set of stored inputs are those are within a pre-specified range of distance and/or compound uncertainty from the target input. The second set may be a sub-set of the first set.

Results are then generated for the target input and the second set of stored inputs in S204. The results for the second set of stored inputs are then updated in the cache, and the result for the target input is calculated again, using the updated stored results for the second set of inputs calculated in the previous iteration. As shown in FIG. 8, in the first iteration, two of the inputs in the first set are also processed as target inputs, resulting in an updated result for these inputs. These two inputs form the second set. In the second iteration, the updated results for these two inputs are used to calculate an updated result for the target input. Optionally, the weights connecting the node in the input layer with the same node in the output layer may be deactivated by setting to zero. Thus in this example, the weights w_{2,2} and w_{3,3} may be set to zero. Alternatively, a range may be set for the weights. A more accurate computation result for the target input may be determined in the second iteration.

Although in the example shown in FIG. 8, additional target inputs are added from the cache to the output layer in order to improve the calculation of the target input, additionally or alternatively, additional target inputs are added from the cache to the output layer in order to improve computational efficiency of an update process via parallel processing. For example, where a target input is to be processed, computational results for existing entries may be updated at the same time. Since the update may be performed using the same matrix calculation used to process the target input, an update to one or more stored entries may be made with only a small additional computational load. Additionally or alternatively, one or more additional new entries may be calculated at the same time, and stored for future use.

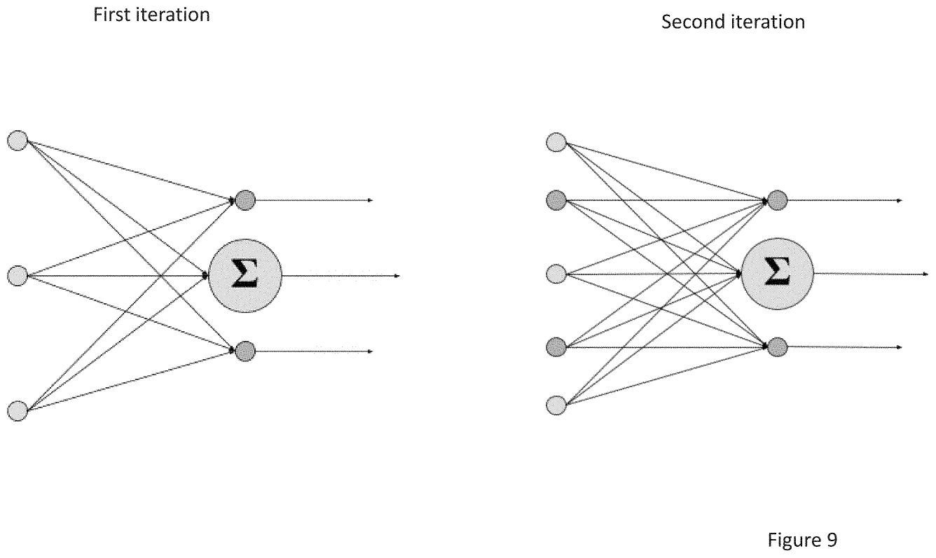

FIG. 9 is a schematic illustration of a method according to an embodiment, in which, in parallel with calculating the output result for a target input in S204, additional nodes are added to the output layer in order to improve the calculation of the target node in future processing. In this example, entries from the output layer of the first iteration become available as inputs in the second iteration. The additional output nodes correspond to one or more additional target inputs which are generated automatically. For example, the one or more additional target inputs are automatically generated within a pre-specified range of distance from the target input. Results are then generated for the target input and additional target inputs in S204. The results for the additional target inputs are then added to the cache, and the result for the target input is calculated again, using the additional stored results for the additional target inputs calculated in the previous iteration. As shown in FIG. 9, in the first iteration, two additional target inputs are processed, resulting in stored results for these inputs. In the second iteration, the stored results for these two additional inputs are added to the first set and are used to calculate an updated result for the target input. The two additional target inputs have been deliberately created near the target input to provide additional information in the next iteration. Rather than being added on the fly to the output layer when processing a target input, the additional target inputs can be pre-added as entries in the cache with no outputs. At a later stage, these blank entries might now satisfy the fourth criteria for inclusion in the output layer when processing nearby target inputs.

Although in the example shown in FIG. 9, additional target inputs are added to the output layer in order to improve the calculation of the target input, additionally or alternatively, additional target inputs are added to the output layer in order to improve computational efficiency of a future calculation via parallel processing. For example, where a target input is to be processed, computational results for likely future target inputs may be calculated at the same time.

As described in FIGS. 8 and 9, calculation of one or more new entries and/or one or more updated entries may be performed in a single process.

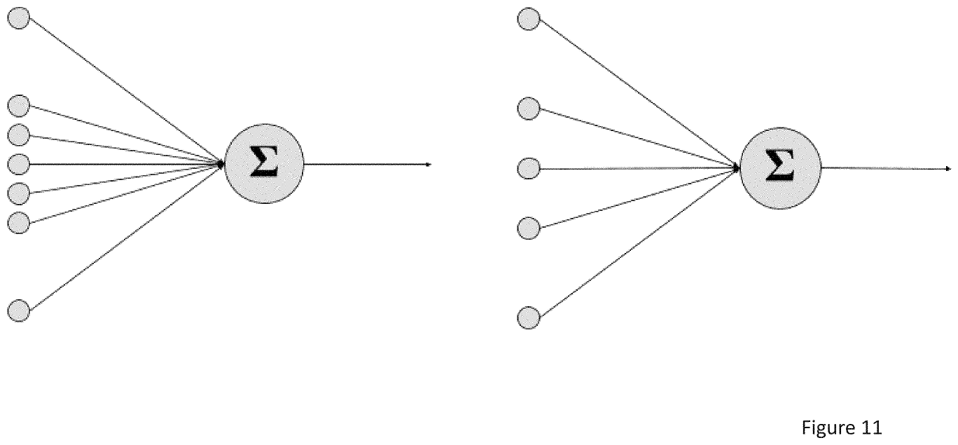

FIG. 11 is a schematic illustration of a method in which, during calculation for a target input in S204, one or more stored inputs in the first set are filtered out and removed from the first set, based on a fifth criteria. For example, the fifth criteria may be based on distance measure and/or compound uncertainty. Identical nodes to the target node can be removed from the first set, for example. Other filter conditions are possible. This is different to removing nodes permanently from the cache—in this case entries are simply not included in the first set but maintained in the cache for future use.

In the methods described above, the system maps an external function f by adding, removing and updating nodes in the cache. For example, there may initially be an empty cache. In this state, the system has no stored knowledge of the function results. Any function request will need to be evaluated with the execution of the full function computation. As the memoization cache is filled with full function results, the memoization module can retrieve and estimate function outputs in more and more cases without needing to run the full function. Memoization provides a mapping between function inputs and outputs, gradually ‘learning’ function f.

System parameters can be improved and optimized based on an error measure between the predicted function evaluation performed in S204 and the actual function evaluation stored. Any system parameter can be iterated to reduce the gap between estimated and actual function evaluations. One or more of the following can be adapted to improve performance for example:
Distance measure;
Function g(d) used in the compound uncertainty function;
Coefficients used in the compound uncertainty function;
Output estimation function (shown in Equation 2);
Uncertainty estimation function (shown in Equation 3);
Filtering conditions used to generate the first set.

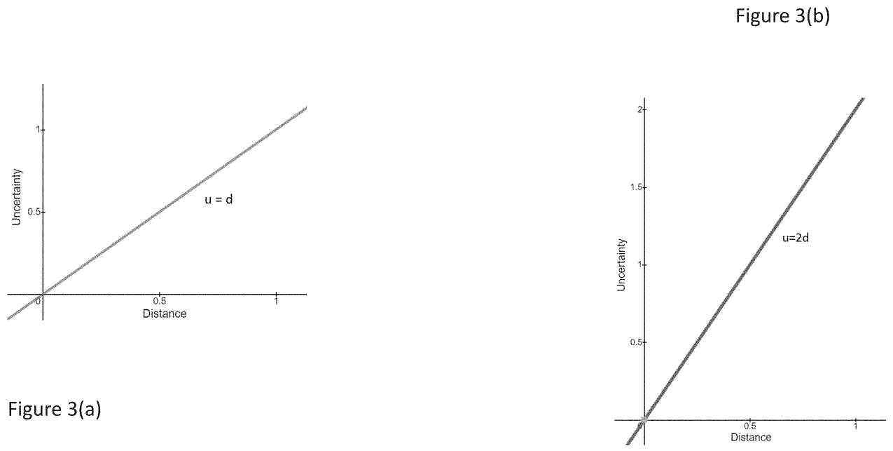

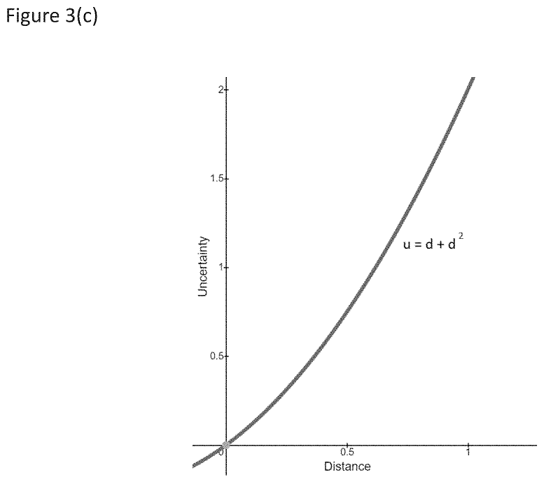

As has been described above, the compound uncertainty may be calculated from: uₛ+g(d)+(g(d)*uₛ), where uₛ is the stored uncertainty at node s. The function g(d) maps uncertainty to distance. A simple but effective monotonic function, g(d)=d, may be selected for example. FIG. 3(a) shows the function g(d)=d.

Optionally, the function g(d) may be optimized in a training stage, performed prior to operation of the system or during system downtime for example. An example involving optimization of g(d) using linear regression will now be described. A training data set used to optimize g(d) can be generated from the cache. The training data set is generated from entries where the stored computational results have a stored uncertainty of zero—these are the results determined by performing the full function f for example.

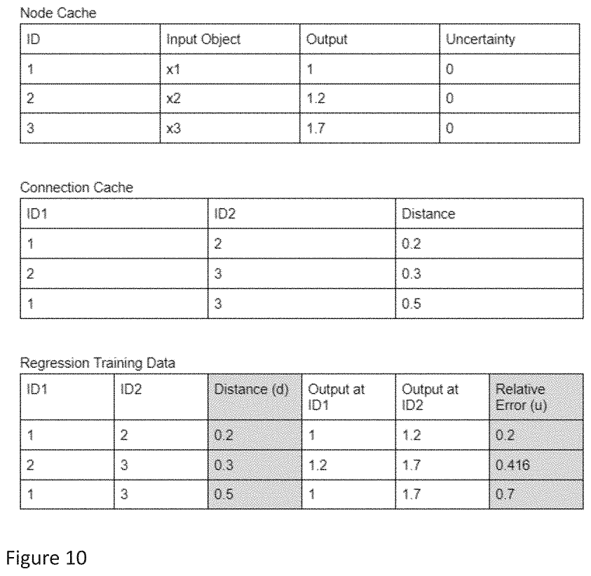

FIG. 10 shows an example of a training data set. As described above, a node cache comprises three stored entries. Each stored entry has an ID, a stored input, a stored computation result (or output) and a stored uncertainty measure. A connection cache stores the distance measure between each pair of stored entries. A training data cache is then generated. For each pair of qualifying stored entries, the following data elements are stored in the training data cache: the distance between the entries in each pair (retrieved from the connection cache) and the relative error (also referred to as the difference) in the computational results between the entries in each pair (calculated from the computational results stored in the node cache). For a first stored output y₁ and a second stored output y₂, the relative error is given by u=abs(y₂−y₁)/y₁.

A dataset of relative error values u (which are a measure of uncertainty) and corresponding distance values d is therefore generated. A relationship between the relative error values u and the distance can then be fit with this dataset, using linear regression. Using linear regression, the distance variable (d) is mapped against the relative error u to determine a relationship of the form u=a +bd. In this case, the relative error u is the dependent variable, and a relationship g(d) of the form g(d)=a +bd, is determined through linear regression. Linear regression is used to determine the line of best fit, giving estimates for parameters a and b, the intersect and the gradient respectively. In this case, the distance measure d is the independent variable and the relative error u is the dependent variable.

FIG. 3(b) shows an example function g(d)=a +bd, where a and b are constants which are determined by performing linear regression as described above. In this case, a=0 and b=2, such that g(d)=2d.

The function g(d) determined through linear regression is then used in the compound uncertainty calculation as described above.

The same training set shown in FIG. 10 could alternatively be used with a non-linear curve fitting methodology such as polynomial regression. For example, a function g(d) of the form a +bd+cd² could be used. FIG. 3(c) shows an example of g(d) found by polynomial regression where a=0, b=1 and c=1, giving g(d)=d+d².

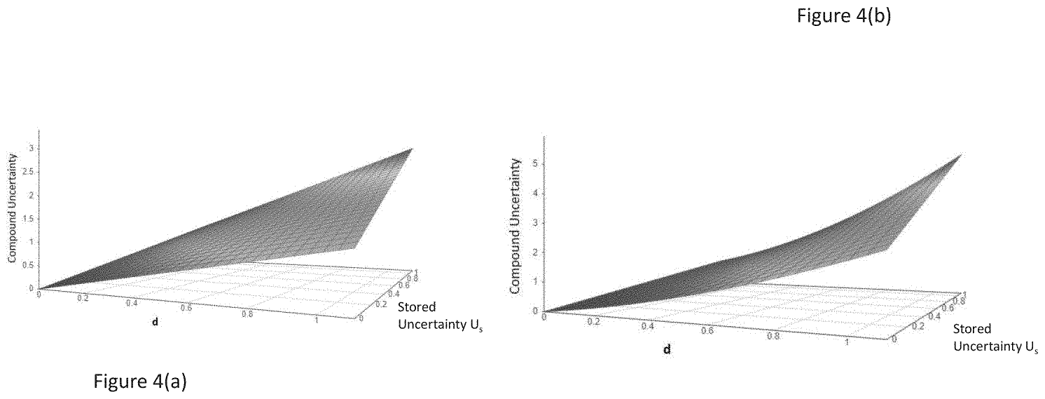

As has been described above, if the function g(d)=d is used, the compound uncertainty reduces to u+d+ud. This function for compound uncertainty is shown in FIG. 4(a). If a function of the form g(d)=d+d² is used, the compound uncertainty becomes u*(d+d²)+u+(d+d²). This function for compound uncertainty is shown in FIG. 4(b).

Though the system functions effectively with a simple function such as g(d)=d, the optimization of this function as described above will result in more effective weightings in the output estimation computation. This in turn results in improved accuracy of the estimated results. The function g(d) might be optimized differently for different functions f. The function g(d) might be optimized differently for different regions of the domain space, i.e. for different inputs.

Other parameters and hyperparameters may be optimized by maximising an overall accuracy of the cache. For example, an overall accuracy may be calculated as the sum of the relative errors between estimated output and actual output for all nodes with uncertainty of 0. As described above, the relative error is the relative error is given by u=abs(y₂−y₁)/y₁. The optimal parameter settings may be sought to maximize this overall accuracy. In this way, many parameters and hyperparameters may be tuned. A dataset comprising a vector corresponding to one or more parameter settings, together with the score for overall accuracy (predicted output to known output as described above) is generated. Optimization techniques for optimization of parameters and/or hyperparameters include those based on grid search, random search, Bayesian optimization and evolutionary optimization.

In the above example, the distance measure is a Manhattan Distance. However, other distance measures such as a Euclidean Distance, Mahalanobis Distance, or some other distance measure may be used. The distance metric may be chosen to be suitable for the function f for which the computation result is to be determined. The below table shows some example distance measures. The optimal distance measure can be determined by maximizing the overall accuracy of the system as described above.

Distance measure
Euclidean Distance
Manhattan Distance
Mahalanobis Distance
Edit Distance
Normalized Compression
Distance
Custom Distance Metric

A Normalized Compression Distance (NCD) is a distance measure that can be calculated between any two digital objects. Every computer file comprises a finite string of 0s and 1s. Each digital object is represented by such a string. For example, each input may be an image file. Each input image corresponds to a file represented by a string of 0s and 1s, where 0's and 1's represent white and black pixels for example. The NCD between a target input image S and a stored input image A is given by:

$$N C D ( S , A ) = \frac{Z ( S A ) - min \{ Z ( S ) , Z ( A ) \}}{max \{ Z ( S ) , Z ( A ) \}} \qquad ( 4 )$$

where Z(x) is the binary length of the string x compressed with compressor Z, and SA is the concatenated strings (i.e. the string S concatenated with the string A), and where 0≤NCD≤1. Binary length refers to the number of bits in the compressed string. Thus the file is compressed, and then the length (i.e. number of bits) of the compressed string is determined. When NCD(S, A)=0, then S and A are similar, if NCD(S, A)=1, they are dissimilar.

Two very similar objects when compressed together (i.e. concatenated and then compressed) will result in a file (i.e. Z(SA)) which is almost as small as compressing a single instance of either object (i.e. Z(S) or Z(A)). The second object introduces very little new information. In other words, Z(SA) will have (almost) the same number of bytes as Z(S) when S=A. The more S looks like A the more redundancy will be met by the compressor, resulting in Z(SA) bytes moving closer to the number of bytes of Z(S). However, the greater the difference between the two concatenated objects, the greater the size of the resulting compression.

The compression Z may be the GZip compression algorithm for example. Different compression algorithms can be used however. Different compression algorithms may be suitable for different applications for example. For example, video compression may be used where detecting transformations such as movement of blocks of pixels. The compressor function Z may be a function compressing the file string.

A second step is performed to return the number of bytes of the compressed strings. The block size of the compressor is selected so that the size of the concatenated string lies within the block size of the compressor. The block size of the compressor may be selected to be 900000 bytes for example.

The choice of compression algorithm used within the Normalized Compression Distance is an example of a parameter that can be optimized by maximizing the overall accuracy of the system.

More than one type of distance measure may be generated for example. These can be combined, for example by taking an average, to give an overall custom distance measure. The specifications of a custom distance measure can be optimized by maximizing the overall accuracy of the system.

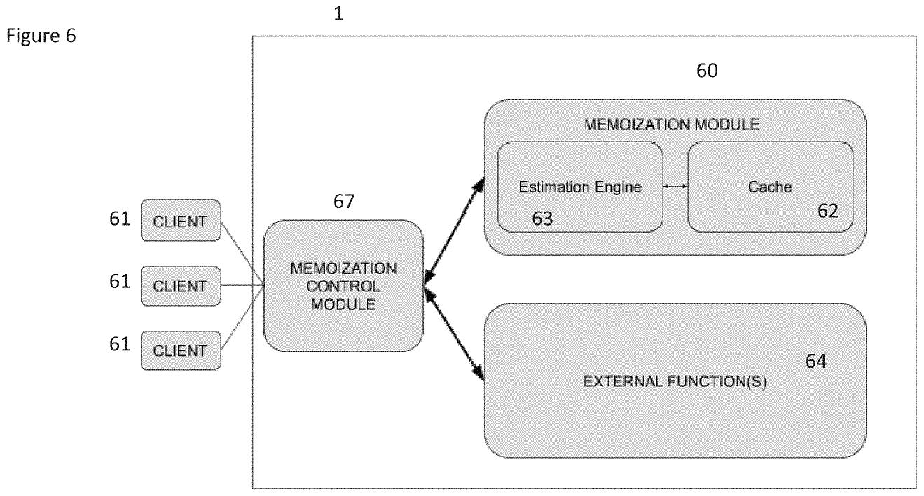

FIG. 6 is a schematic illustration of an example system 1 according to an embodiment. The system 1 communicates with multiple clients 61. Each client 61 communicates with a memoization control module 67 in the system 1. The system 1 may comprise the hardware components described in relation to FIG. 1 for example, where the system comprises at least one graphical processing unit (GPU) and a general central processing unit (CPU).

The control module 67 comprises computer program code that is implemented by the CPU. The control module 67 handles the overall process flow. For example, a request for a function result from a client is passed to the control module 67. The control module 67 calls the memoization module 60, and requests a computational result. If the memoization module 60 does not return a satisfactory result to the control module 67, the control module 67 calls the external function module 64 for the result. The control module 67 then passes the result to the memoization module 60 to be stored in the cache. The control module 67 also returns the result back to the user.

The memoization module 60 comprises computer program code that is implemented by the CPU. The memoization module comprises computer program code that controls storage and retrieval of data from the memory cache 62. The memory cache 62 comprises the node cache described above. The memory cache 62 uses cache storage, for example memory or a solid state storage device. The memory cache 62 may be stored in the system storage 7. The memoization module 60 functionality may further include one or more of the following core cache functions: get estimate, process cache, insert stored entry, update stored entry, delete stored entry.

The memoization module 60 further comprises computer program code that when executed, performs the function estimation. This is also referred to as the function estimation engine 63. This performs the determination described in S204 above. At least part of the functionality of the function estimation is performed on the GPU. The estimation engine 63 performs distance calculations, distance based retrieval and matrix calculations for example. Such methods may be performed more efficiently on a GPU.

An external function module 64 performs the full calculation described in S205 above. The external function module 64 comprises computer program code that is implemented by the CPU.

The control module 67, memoization module 60 and external function module 64 are implemented as computer program code stored in the storage 7 of a system such as described in relation to FIG. 1. The code is placed in working memory 11 when executed. Various parts of the code may be executed by the GPU.

The control module 67 is able to process many concurrent client requests. Memory cache 62 stores and retrieves inputs and their associated outputs and uncertainties. The function estimation engine 63 calculates an estimated function output and associated uncertainty for a given input as described in S204 above. The result is stored in the memory cache 62 for future use. The external function module 64, when necessary, runs the full function. Again, the inputs and outputs are stored in the memory cache 62 for future use.

### First Example

A first example relating to feature detection in a video security system will now be described. In this example, the input data comprises an image file comprising an image taken from a video feed from a security video camera monitoring a front porch. The computation result is an output which represents whether a package is present. The computation comprises a function f, which for example may comprise a neural network based classifier which outputs a value from 0 to 1, with 0 indicating no package and 1 indicating presence of a package, based on the input pixel values. In this manner, a real-time alert may be given to a user if a package has been left on the porch.

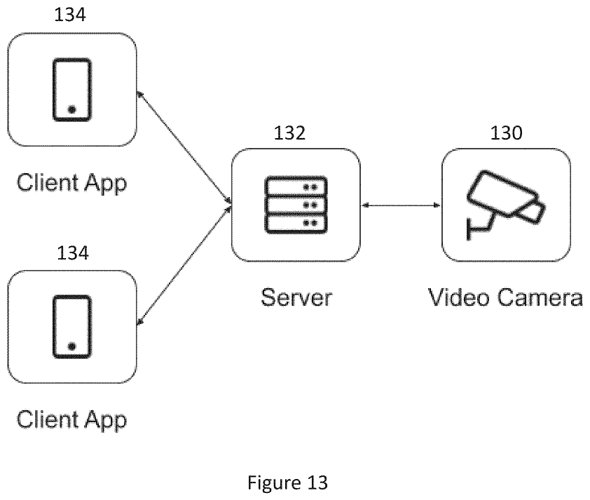

FIG. 13 shows a system in accordance with an embodiment which may be used in this example, which comprises a video camera 130 obtaining the input images. The image data is sent to a server 132, which performs the method as described below, to obtain a computational result (a value from 0 to 1) corresponding to an input image. The computation result may be sent from the server 132 to one or more devices running a client app 134. Further processing may be performed on the computation result before it is sent to the client devices. For example, if the computation result is greater than or equal to 0.5, an alert is generated at the server 132 and sent to the client device. The video camera 130 sends an image to the server 132 at regular intervals, for example every 5 minutes, for processing using the cache. If a package is detected the presence of a package is flagged in the app 134.

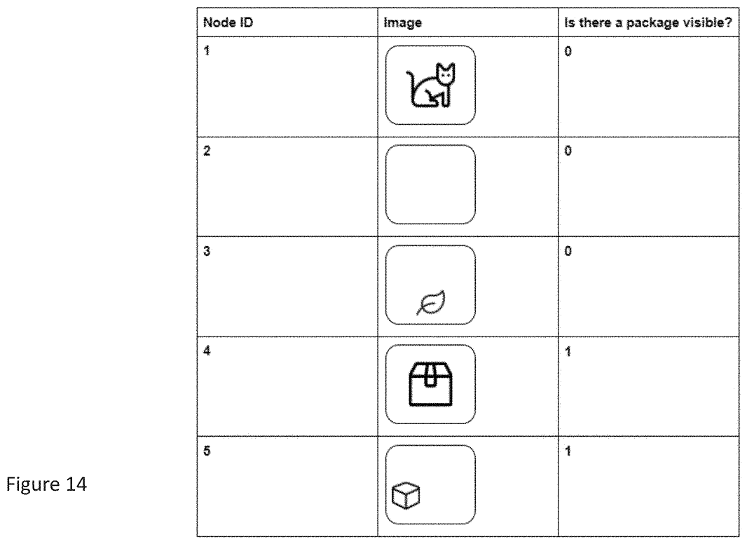

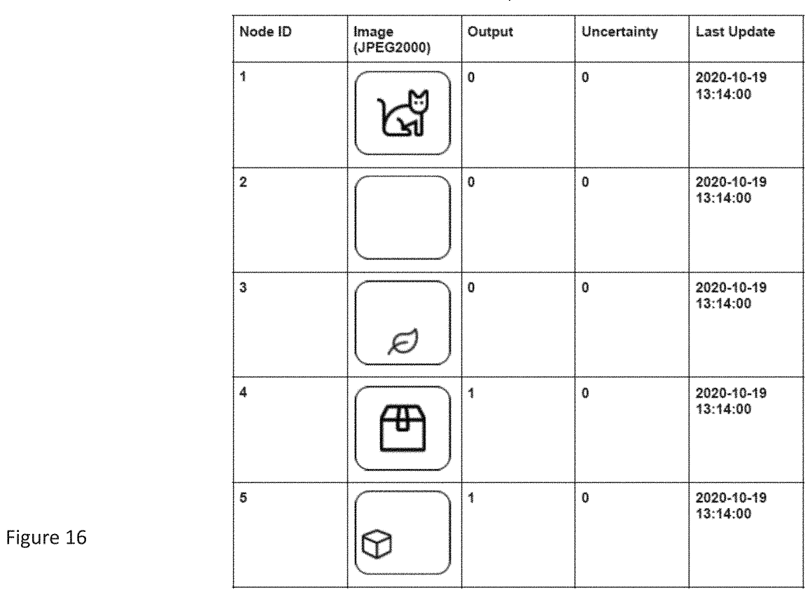

A node cache stored on the server 132 comprises a number of images, in this case 100 images. These correspond to the stored inputs. These images correspond to a variety of doorstep scenarios and the known outputs (0 or 1) indicating the presence of a package. The cache comprises the stored images (stored inputs) and corresponding stored computational results (0 or 1) obtained from computing the full function f, i.e. comprising the neural network based classifier. FIG. 14 shows a schematic illustration of some of the data stored in the node cache. An example of the structure of the cache is shown in FIG. 16. Each stored image is identified by a NodeID, in this case a number. Each stored image is stored together with the stored computational result (output) and the stored uncertainty measure. For all of the stored images shown, the result was obtained by running the full computation f, and therefore the uncertainty is 0. A time stamp of when the entry was last updated may also be stored. The cache may be referred to as a “node cache”.

As described in relation to S202 of FIG. 2(a), when a new input image file (target image) is received, a distance measure between the target image and each stored image is obtained. In this example, the distance measure is calculated using a Normalized Compression Distance between the target image file and the stored image file. The NCD has been described above. A JPEG2000 compressor may be used.

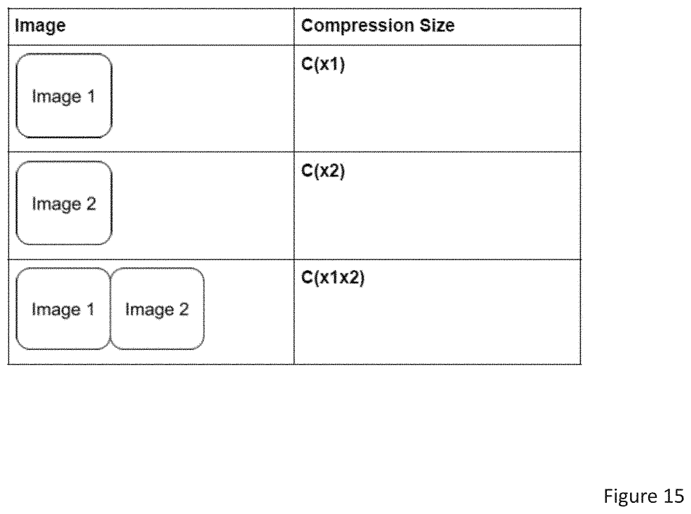

FIG. 15 illustrates a compression size of a target image file string (image 1), labelled C(x1), and of a stored image file string (image 2), labelled C(x2). The compression size of the concatenated file strings (i.e. the file string of image 1 concatenated with the file string of image 2), is labelled C(x1x2). The NCD is a value between 0 and 1 and is given by:

$$N C D ( x 1 , x 2 ) = \frac{C ( x 1 x 2 ) - min \{ C ( x 1 ) , C ( x 2 ) \}}{max \{ C ( x 1 ) , C ( x 2 ) \}}$$

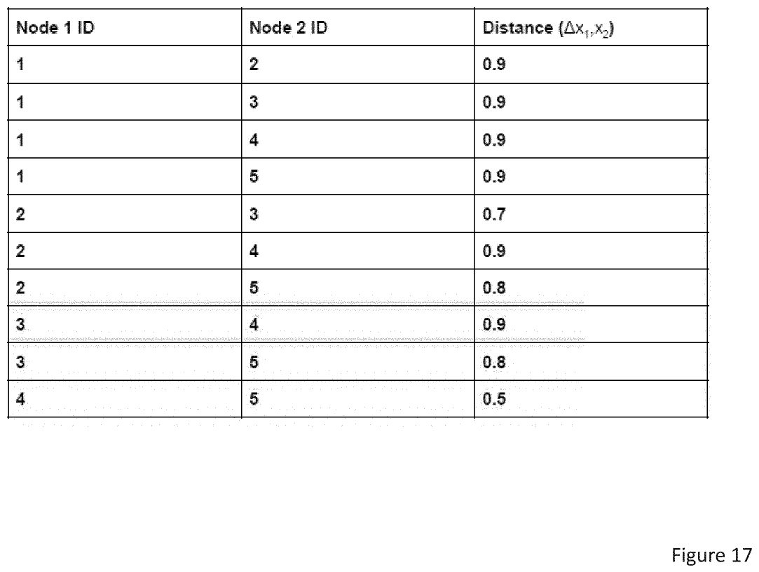

As has been described above, a distance matrix may be populated with the distance measures Δ between each of the stored images, and between each of the stored images and the target image. An example structure for storing the distance measures is shown in FIG. 17, and is referred to as the connection cache.

For a new input image, also referred to as a “target node”, a computational result is obtained by first calculating a distance from each node in the node cache, as described in relation to S202 above.

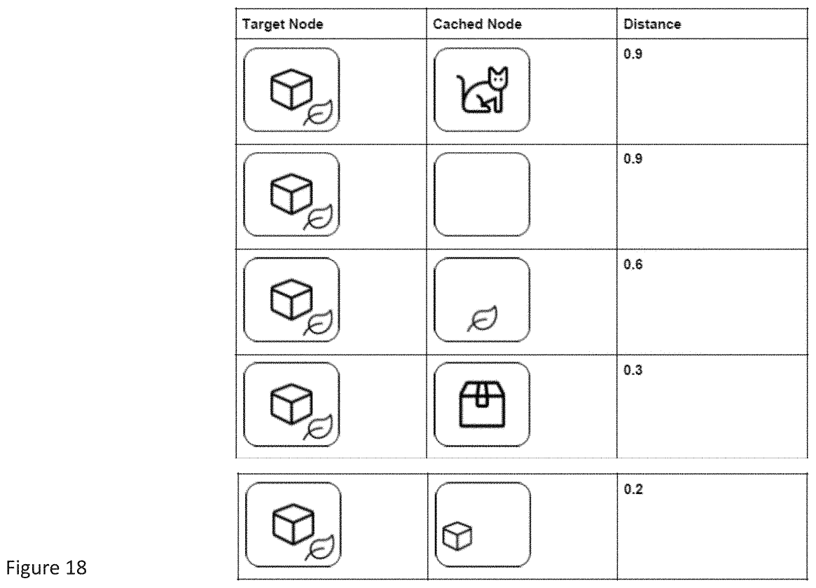

It is then determined whether each stored entry meets the first criteria, as described in relation to S203 above. In this example, the first criteria is that the distance of the node from the target node is less than 0.7. In addition, the stored uncertainty of each stored entry must be less than 0.5. In this example, three stored entries meet the first criteria: entries 3, 4 and 5, as shown in FIG. 18. The first set comprises entries 3, 4 and 5.

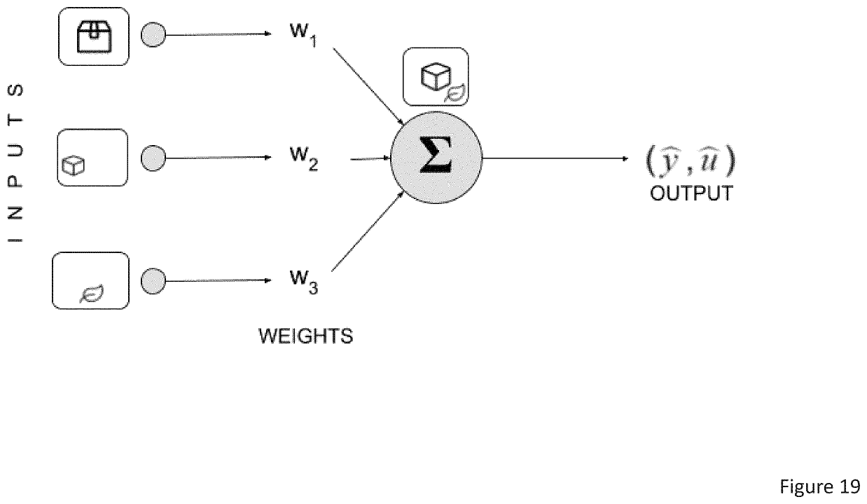

In S204, an estimated result is determined from the cache. An illustration is shown in FIG. 19. This step comprises selecting the first set of results (a first set of input nodes) from the cache according to the first criteria and determining the output.

The weights, output and uncertainty are calculated using equations (1), (2) and (3) as described above. In this case, y₁=1, y₂=1 and y₃=0. Furthermore, u_{z,1}=0.3, U_{z,2}=0.2 and U_{z,3}=0.6. w₁=1/0.3=3.3, w₂=1/0.2=5 and w₃=1/0.6=1.67. ŷ=0.83 and û=0.24.

The determined computation result ŷ=0.83 and computation uncertainty û=0.24 are stored in the cache with the input image as a new stored entry. The distance measures are stored in the connection cache. A further step is applied to provide the output to the client devices. In particular, if ŷ is greater than or equal to 0.5, an output value of 1 is determined and the user is alerted to the package. If ŷ is less than 0.5, an output value of 0 is determined, and the user is not alerted to a package.

During the operation, the system will raise a flag for the presence (1) of a package. The criteria for alerting the user to the presence of a package may be based on some other function of the computation result and computation uncertainty, and the raw computation result and computation uncertainty may be output too.

In this example, the following “default” parameters are used:

Distance metric: JPEG2000
Distance metric customization: none
Distance function used in compound uncertainty function: g(d)=d
Compound uncertainty function: u+g(d)+(g(d)*u)
Output function: Equation (2)
Uncertainty function: Equation (3)
Node filtering strategies: none

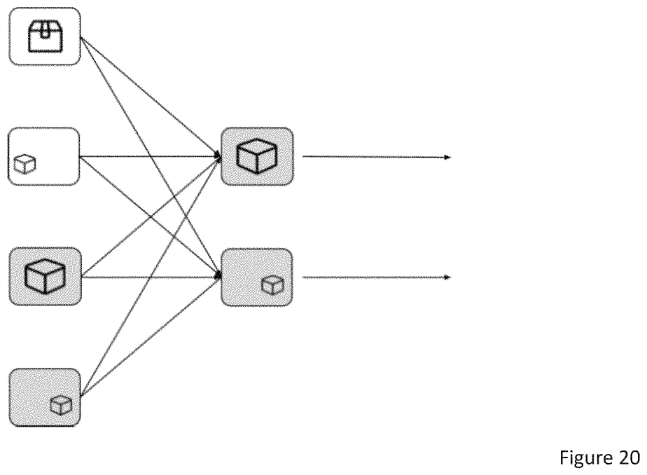

FIG. 20 illustrates an alternative method in which the estimation engine uses recursion. In this method, input nodes are selected from the cache where the distance from the target node is greater than a minimum threshold and less than a maximum threshold. Output nodes are also selected from the cache where the distance from the target node is greater than the minimum threshold and less than the maximum threshold, and where the compound uncertainty is greater than a minimum threshold and less than a maximum threshold. The outputs and uncertainties are calculated for the output nodes, and the cache updated with the new node outputs and uncertainties. This is iterated a fixed number of times, or until a convergence threshold is reached.

As described above, various cache maintenance tasks may also be performed, for example background propagation of information through network. In this procedure, stored entries where the stored uncertainty is greater than 0 may be selected, and re-processed. An updated computation result and computation uncertainty are calculated by applying the method of FIG. 7(f), and the stored entry updated with the new computation result and computation uncertainty. Additionally or alternatively, stored entries having a last update date later than a pre-determined date are selected and updated by applying the method of FIG. 7(f). The pre-determined date may be 1 day ago for example.

A background process which removes nodes in areas of high density may also be performed.

Any ongoing known outputs (for example human feedback via an app or automated full function calculation) can also be updated in the cache. Optionally, as described above, the parameters of the system can be optimized to enhance the performance of the system.

Although in the above example, the full computation is performed using an automated function, for example a cloud based neural network feature detection system, alternatively the full computation may involve human detection, for example via an app.

In the above example, only a single binary output is obtained, i.e. 1 for package, 0 for no package. However, in the case where an additional type of output is required, for example detecting a person, a separate method is performed using a separate cache of results corresponding to the additional output type.

### Second Example

This example relates to the use of caching and memoization for obtaining a computational result of a function based on the Ackley Function. In this example, a method of obtaining a result of a complex function based on the Ackley Function in 5 dimensions, is described. The Ackley function, referred to here as f₁, is given below:

$${f}_{1} ( {x}_{1} , {x}_{2} , {x}_{3} , {x}_{4} , {x}_{5} ) = - 20 exp [ - 0.2 \sqrt{0.5 ( {x}_{1}^{2} + {x}_{2}^{2} + {x}_{3}^{2} + {x}_{4}^{2} + {x}_{5}^{2} )} ] - exp [ 0.5 ( cos 2 π {x}_{1} + cos 2 π {x}_{2} + cos 2 π {x}_{3} + cos 2 π {x}_{4} + cos 2 π {x}_{5} ) ] + exp ( 1 ) + 20$$

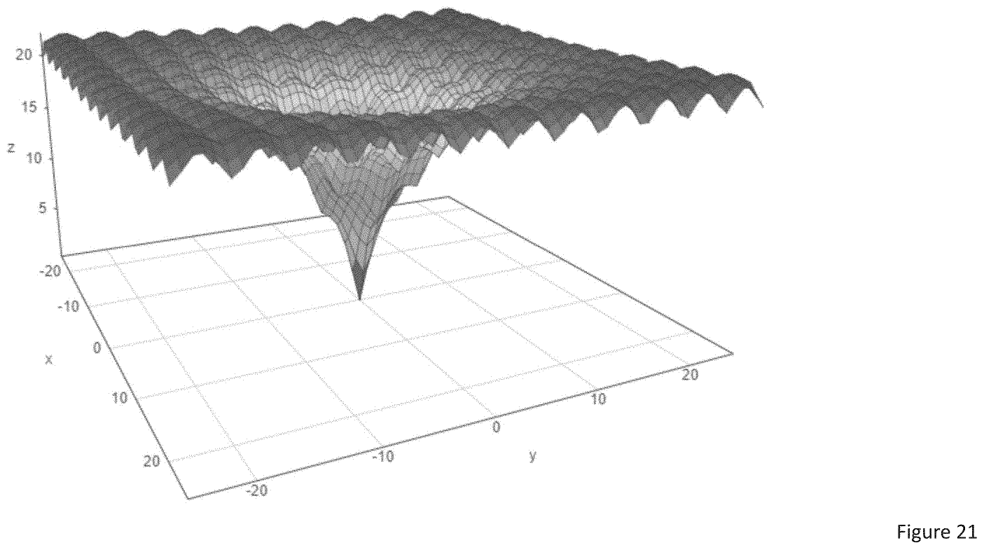

The Ackley function is a function that may be used to test optimization algorithms, since it has many local minima, as illustrated in FIG. 21. In this example, a genetic algorithm based approach is used to find the global minimum of the function f₁. The example is implemented by finding the maximum of the function f=−(f₁) In a genetic algorithm based approach, the output of the function f will need to be calculated multiple times for different inputs. In order to reduce the number of times the complex function f needs to be called to find the maximum, the genetic algorithm based approach is modified in the manner described below.

The full computation in this case comprises determining the result of the function f. This is the computational result. In this example, the computational result is also referred to as the “fitness value”, where the fitness function of the genetic algorithm is set to the complex function −(f₁).

The goal of the operation is determine the input values, i.e. the set of values (x₁, x₂, x₃, x₄, x₅) that maximises the function f. In order to do this, it may be necessary to run the function f for various inputs. Performing the function f multiple times for various inputs can be implemented efficiently using the below described method. In this way, the input that minimises the function f can be determined more efficiently.

In this example the inputs are points in 5 dimensional space, each dimension being between −10 and +10. Thus a target input may be (1, 2, 4, −3, 9) for example.

A first set of 40 target inputs are generated at random. These are referred to as the first generation inputs. At this point, there are no stored results in the cache, and therefore the full function f is performed for each target input as in S205. The computational results of the full function f are stored in the cache, with an uncertainty measure of zero. Thus at this stage, the cache comprises 40 stored entries, each comprising the inputs, the computation results, and a stored uncertainty of 0.

A new set of 40 target inputs is generated based on the first generation target inputs with the highest computation results. In this step, 40 new inputs are generated. These are referred to as the second generation inputs. The method for generating the new set of inputs is via random mutation and recombination of the inputs of the best performing target input(s) of the first generation (i.e. those with the highest computational results, since the goal is to find the input which gives the maximum value of the function f). The target inputs with the highest computational results contribute more to the generation of the new set. The target input with the highest computational result is carried forward unchanged.

For each new target input in the second generation and later, a computational result is obtained by first calculating a distance from each node in the node cache, as described in relation to S202 above. In this example, the distance measure is a Normalized Manhattan Distance as described above:

$$NormManhattanDist ( u , v ) = {\sum }_{i = 1}^{n} \frac{\vert u [ i ] - v [ i ] \vert}{n}$$

where u[i] is the target input, for example (1, 2, 4, −3, 9), and v[i] is a stored input, for example (−3, 6, 3, 7, −2). The normalised Manhattan Distance in this case is 0.3. The Normalized Manhattan Distance is a value between 0 and 1.

Step S203 is then performed for each of the new target inputs in the second generation. In this example the first criteria is set to have a distance threshold of 0.75 and an uncertainty threshold of 0.75. A computation result and computation uncertainty is then determined for each of the second generation inputs. For each of the second generation inputs, if a stored entry meets the first criteria, a first computation result and a first computation uncertainty is determined using a first set of stored entries meeting the first criteria as described above in relation to S204. For any of the second generation inputs where no stored entries meet the first criteria, the full function f is run as described in S205. The computation results and computation uncertainties are stored in the cache in S206 as stored entries.

Optionally, the above steps are repeated for each second generation entry, so that the computation result and computation uncertainties for the second generation entries are updated based on the other second generation entries. This process may be repeated more than once. This is referred to as recursion using sibling members.

The eight stored entries from the second generation having the lowest computation result are then identified and discarded. The full function f is then run for the remaining stored entries from the second generation, and the computation results and computation uncertainties are updated.

A new set of 40 target inputs is generated based on the highest computation results in the same way as for the previous iteration, and the process repeated.

For each generation, when the function f is calculated for each member, the inputs and outputs are stored as entries in the cache. Optionally, old generations are discarded from the cache. As a new generation of members is generated, all members are entered into the cache as stored entries with no output.

Optionally, when the calculation result is to be determined, the result from an existing stored entry is returned if uncertainty is less than a threshold value, as described in S203a in relation to FIG. 2(b) above. The second criteria in this case is that the compound uncertainty is less than a threshold value. If the second criteria is not met, the estimation engine generates an estimated computation result and computation uncertainty in S204, as described above.

Although in the above process, the eight entries having the lowest computation result are discarded, optionally, this criteria may be based on a combination of the computation result and the computation uncertainty. For example, it may be desirable to retain the entries having the highest computational result and the lowest computation uncertainty.

Two specific examples and two comparative examples will now be described, together with the results. In these examples, the function f₁ is the Ackley function with 5 dimensions, where a=20, b=0.2, and c=2*pi. The full population is 40 members, in other words, at each generation, 40 new inputs are generated. The culled population is 32 members, in other words, 8 entries are discarded from each generation. Only one entry is retained unchanged in the next generation of inputs—that with the highest computational result. Nodes stored from prior generations are discarded from the cache. In this example, only the nodes from one previous generation are stored.

### Example 1 Process

1. Generate 40 generation n inputs;

2. Compute computational result and computational uncertainty for all 40 inputs using process described above, where step S204 is performed if first criteria is met, and the full function f is performed if the first criteria is not met;

3. Discard 8 members with the lowest computational result;

4. Execute full function f for entries where full function f was not performed in step 2, for remaining 32 entries only;

5. Proceed to generation n+1;

6. Generate 40 generation n+1 members.

### Example 2 Process

1. Generate 40 generation n inputs;

2. Compute computational result and computational uncertainty for all 40 inputs using process described above, where step S204 is performed if first criteria is met, together with recursion—steps are repeated for each n generation entry, so that the computation result and computation uncertainties are updated based on the other n generation entries, and the full function f is performed if the first criteria is not met;

3. Discard 8 members with the lowest computational result;

4. Execute full function f for entries where full function f was not performed in step 2, for remaining 32 entries only;

5. Proceed to generation n+1;

6. Generate 40 generation n+1 members.

### Comparative Example 1 Process

1. Generate 40 generation n inputs;

2. Discard 8 randomly selected inputs

3. Execute full function f for remaining 32 inputs only;

4. Proceed to generation n+1;

5. Generate 40 generation n+1 inputs.

### Comparative Example 2 Process

1. Generate 40 generation n inputs;

2. Execute full function f for all 40 inputs;

3. Discard 8 inputs with the lowest computation result;

4. Execute full function f only for remaining 32 entries;

5. Proceed to generation n+1;

6. Generate 40 generation n+1 inputs.

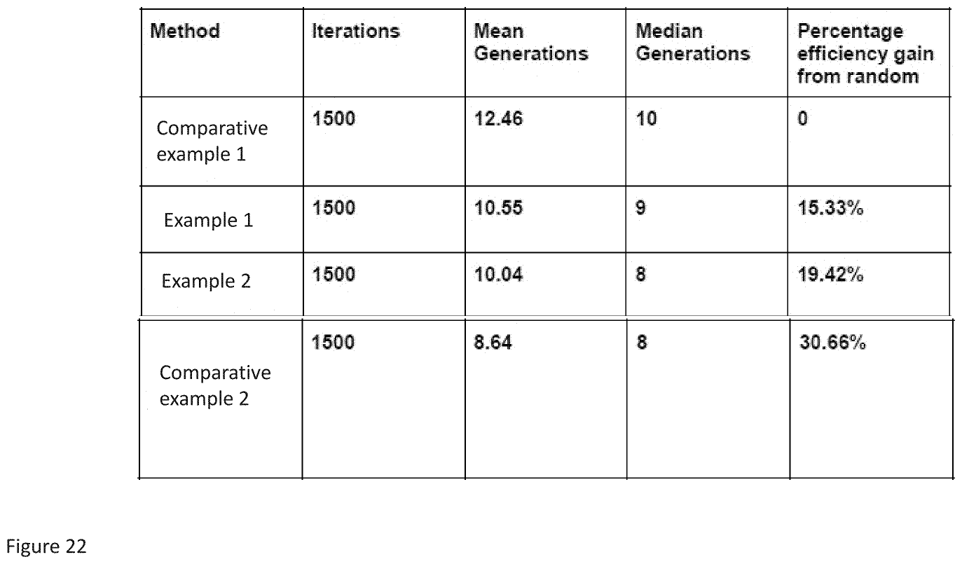

FIG. 22 shows the results for the example processes described above. For each example process, the process was performed 1500 times. The maximum number of generations was set at 20, meaning the process was stopped at 20 generations. The process was also stopped if a computation result of −3 was obtained. The mean number of generations and median number of generations to reach the computational result of −3 is given for each example. The value of −3 was selected as a value near to the global maximum of 0.

For comparative example 1, the mean number of generations to reach the computational result −3 was 12.46 and the median was 10. As shown, both example 1 and example 2 reached the result of −3 more quickly, with a mean number of generations of 10.55 and 10.04 respectively, and a median number of 9 and 8 respectively. For comparative example 2, the mean number of generations was 8.64 and the median number of generations was 8. This is the theoretical limit of efficiency for the first and second examples.

Example 1 produced a 15.33% percentage efficiency gain over comparative example 1, example 2 produced a 19.42% efficiency gain over comparative example 1, and comparative example 2 produced a 30.66% efficiency gain over comparative example

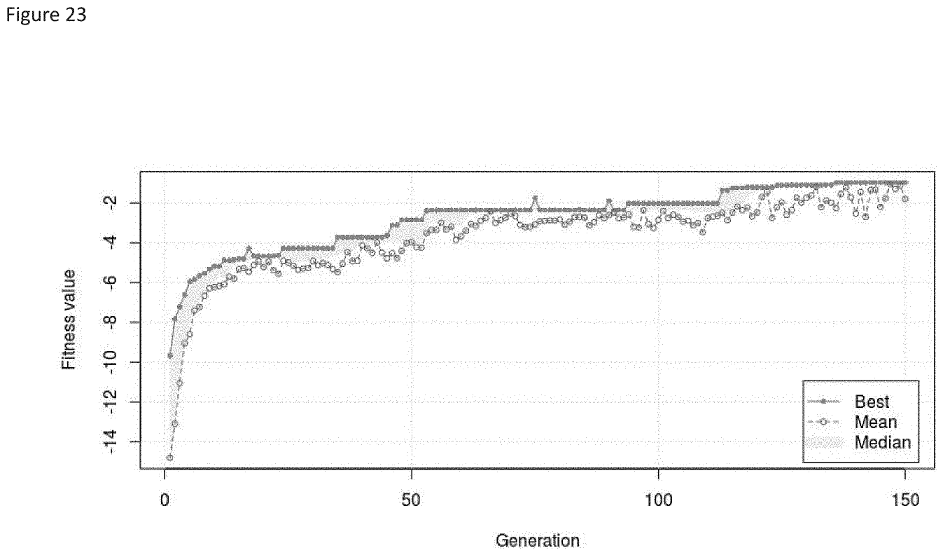

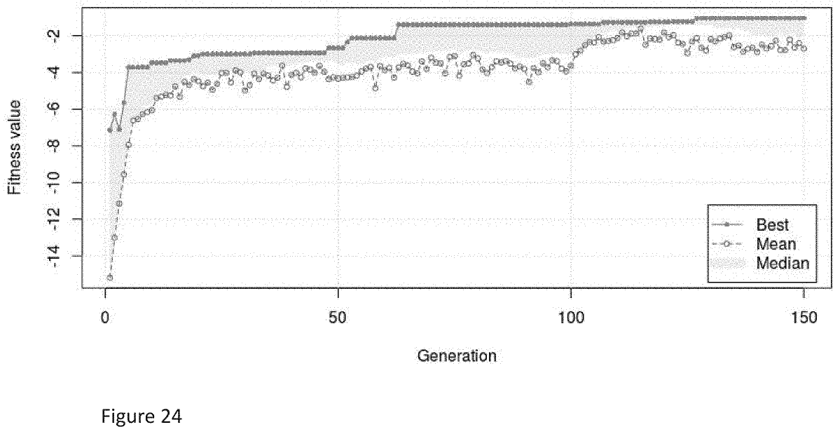

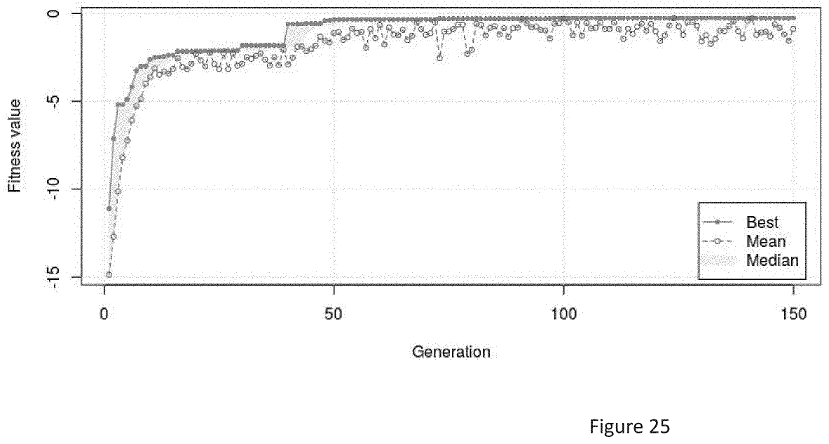

FIG. 23 shows the results for a single instance using the process of comparative example 1, running for 150 generations. This figure shows a graph of the best computation result for each generation, against the generation number. The vertical axis is labelled “fitness value”—as described above, the fitness value is the computational result of the function f. The square points show the best computation result in each generation. The circular points shown the mean results. The shaded line shows the median. FIG. 24 shows the results for a single instance using the process of Example 1, running for 150 generations. FIG. 25 shows the results for a single instance using the process of Example 2, running for 150 generations. As shown, Example 2 converges in the smallest number of generations, followed by Example 1. Both Example 1 and Example 2 converge more quickly than Comparative Example 1.

The above described methods provide an adapted memoization process, using function caching, which may be implemented on a client and server computer network for example. The method can be used to provide improved efficiency for processes using, for example, artificial intelligence algorithms (as shown in the First Example), pattern recognition algorithms, and global optimization algorithms (as shown in the Second Example).

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made.

1. A computer implemented method of obtaining a computation result, comprising:
obtaining a first input;
determining a distance measure between the first input and each of a plurality of stored entries, each of the plurality of stored entries comprising a stored input, a stored computation result and a stored uncertainty measure;
determining if a stored entry meets a first criteria, wherein the first criteria is based on the distance measure and the stored uncertainty measure;
if a stored entry meets the first criteria, determining a first computation result and a first computation uncertainty for the first input using a first set of one or more stored entries meeting the first criteria; and
storing the first input, the first computation result and the first computation uncertainty as a first stored entry.

2. The method according to claim 1, further comprising, if a stored entry meets the first criteria, determining if a stored entry meets a second criteria, wherein the second criteria is based on the distance measure; and if a stored entry meets the second criteria, providing a stored computation result corresponding to a stored entry meeting the second criteria as the computation result of the first input.

3. The method according claim 2, wherein the second criteria is also based on the stored uncertainty measure.

4. The method according to claim 1, wherein determining the computation result comprises computing a weighted combination of the first set of stored computation results.

5. The method according to claim 4, wherein the weights are determined based on the distance measures and the stored uncertainties.

6. The method according to claim 4, wherein computing the weighted combination comprises one or more matrix calculations.

7. The method according to claim 1, further comprising:
identifying a stored entry to be updated;
determining an updated computation result and a computation uncertainty for the stored entry to be updated using a set of one or more other stored entries meeting the first criteria; and
storing the updated computation result and the computation uncertainty as the updated stored entry.

8. The method according to claim 7, wherein a stored entry to be updated is identified based on at least one of: a time from the previous update, information indicating the source of the stored entry, the stored uncertainty measure or one or more stored distance measures.

9. The method according to claim 1, further comprising:
identifying a plurality of stored entries to be updated, determining an updated computation result and a computation uncertainty for each of the stored entries to be updated using a set of one or more other stored entries meeting the first criteria, and storing the updated computation results and the computation uncertainties as the updated stored entries, and/or
obtaining a plurality of inputs, for each of the plurality of inputs: determining a distance measure between the input and each of a plurality of stored entries; determining if a stored entry meets the first criteria; if a stored entry meets the first criteria, determining a computation result and a computation uncertainty for the input using a set of one or more stored entries meeting the first criteria; and storing the input, the computation result and the computation uncertainty as a stored entry;
wherein the computation results for the plurality of inputs and/or the plurality of stored entries are determined in a combined calculation.

10. The method according to claim 1, further comprising:
determining whether the first computation result meets a third criteria, wherein the third criteria is based on the computational uncertainty;
if the estimated result does not meet the third criteria, performing calculation of a full computation; and
if the estimated result does meet the third criteria, storing the first input, the first computation result and the first computation uncertainty as the first stored entry.

11. The method according to claim 1, further comprising:
deleting one or more stored entries based on a distance measure, the computational result and/or the uncertainty.

12. The method according to claim 1, wherein the first criteria comprises a first condition that the distance measure for the stored entry meets a first threshold and a second condition that the stored uncertainty measure for the stored entry meets a second threshold.

13. The method according to claim 1, further comprising storing the distance measures.

14. The method according to claim 1, determining if the first computation result meets a sixth criteria, wherein the sixth criteria is based on the distance measure or the first computation uncertainty, and if the first computation result meets the sixth criteria, storing the first stored entry as a new entry.

15. The method according to claim 1, determining if the first computation result meets a seventh criteria, wherein the seventh criteria is based on the distance measure or the first computation uncertainty, and if the first computation result meets the seventh criteria, storing the first input, the first computation result and the first computation uncertainty as a first stored entry comprises updating a first stored entry.

16. The method according to claim 1, wherein the first set of one or more stored entries is selected by applying one or more conditions, including one or more of: that the first set has a maximum number of stored entries, that the first set has a minimum of stored entries, that the first set does not comprise any stored entries within a pre-determined distance of each other, or that the first set does not comprise any stored entries within a pre-determined distance of the first entry.

17. The method according to claim 1, wherein the first input data and the stored data comprise image data.

18. The method according to claim 17, wherein the computation result is an indication of whether a feature is detected in the image.

19. A system comprising:
an input configured to receive a first input;
an output configured to provide a computation result;
a memory configured to store a plurality of stored entries;
one or more processors configured to:
determine a distance measure between the first input and each of a plurality of stored entries, each of the plurality of stored entries comprising a stored input, a stored computation result and a stored uncertainty measure;
determine if a stored entry meets a first criteria, wherein the first criteria is based on the distance measure and the stored uncertainty measure;
if a stored entry meets the first criteria, determine a first computation result and a first computation uncertainty for the first input using a first set of one or more stored entries meeting the first criteria; and
store the first input, the first computation result and the first computation uncertainty in the memory as a first stored entry.

20. A non-transitory carrier medium comprising computer readable code configured to cause a computer to perform the method of claim 1.
